(19) United States
(12) Patent Application Publication
(10) Pub. No.: US 2022/0218083 A1
(43) Pub. Date: Jul. 14, 2022

(54) HEADPHONE STORAGE AND CARRYING DEVICES

(71) Applicant: CATALYST LIFESTYLE LIMITED, Hong Kong (HK)

(72) Inventors: Joshua Wright, Hong Kong (HK); June Lai, Hong Kong (HK)

(73) Assignee: CATALYST LIFESTYLE LIMITED, Hong Kong (HK)

(21) Appl. No.: 17/574,228

(22) Filed: Jan. 12, 2022

Related U.S. Application Data
(60) Provisional application No. 63/136,557, filed on Jan. 12, 2021.

(51) Int. Cl. A45C 11/00; A45C 13/00; A45C 13/02; A45C 15/00; H02J 7/00; H04R 1/10

(52) U.S. Cl. CPC A45C 11/00; A45C 13/005; A45C 13/02; H02J 50/90; H02J 7/0044; H04R 1/1025; A45C 2011/001; A45C 15/00

(57) ABSTRACT

Protective cases for electronic devices such as headphones are disclosed. One protective case for headphones includes a body defining a cavity for receiving and enclosing ear cups of the headphones. The body includes at least one wall defining a plurality of apertures therethrough that allow a headband of the headphones to extend through the plurality of apertures.

### CROSS-REFERENCE TO RELATED APPLICATION

The present application claims the priority benefit of U.S. Provisional Patent Application Ser. No. 63/136,557, entitled “HEADPHONE STORAGE AND CARRYING DEVICES” and filed Jan. 12, 2021, the entire contents of which is incorporated herein by reference.

### TECHNICAL FIELD

The present specification generally relates to cases that cover electronic devices for the purposes of protecting during storage and transport and, more specifically, to cases that include features for holding and protecting headphones.

### BACKGROUND

As mobile devices such as laptops, smartphones, tablets, or the like become increasingly used in everyday lives and transported around, the accessories that go with the mobile devices must also be transported. One such accessory that is transported is headphones. Some headphones, particularly those that are over-the-ear headphones, are desired by consumers because of the superior sound quality and noise cancellation features they provide, as well as a design that is viewed by some as a fashion accessory. However, the bulkiness of the over-the-ear headphones lends to some difficulty in storing, transporting, and protecting the headphones. Existing protective cases for over-the-ear headphones may not prevent the headphones (and/or other electronic devices) from getting scratched, dinged, marred, contacted with fluid (e.g., wet), or the like. In addition, existing protective cases may not absorb an impact sustained when dropped. Users may desire to attach certain accessories to the protective case in order to minimize the amount of items that have to be carried, such as, for example, wallets, stands, key rings, clips, carabiners, trinkets, supplemental battery packs, solar panels, or the like. Existing protective cases do not have a standard system that allows for mounting of different accessories via the same connectors on the case. In addition, existing protective cases may not particularly shaped and sized to correspond to a particular type of over-the-ear headphones and may not include features for ensuring a particular fit of the headphones within the case, ensuring that the headphones are turned off, and/or the like.

### SUMMARY

In an aspect, a protective case for headphones includes a body having a first portion and a second portion hingedly coupled together. The first portion and the second portion define a cavity for receiving ear cups of the headphones. The first portion and/or the second portion include a plurality of apertures through walls of the body that allow a headband of the headphones to extend therethrough. The first portion and the second portion are joinable together to enclose the ear cups of the headphones within the cavity.

In another aspect, a protective case for headphones includes a body defining a cavity for receiving and enclosing ear cups of the headphones. The body includes at least one wall defining a plurality of apertures therethrough that allow a headband of the headphones to extend through the plurality of apertures.

In yet another aspect, a protective case for headphones includes a body having defining a cavity for receiving and enclosing ear cups of the headphones. The body includes at least one wall defining a plurality of apertures therethrough that allow a headband of the headphones to extend through the plurality of apertures. The protective case further includes one or more internal walls disposed within the cavity that include a magnet and/or wireless charging features. The protective case further includes a pouch removably coupled to the body. The pouch includes an interior for receiving the protective case therein when detached.

Additional features and advantages of the aspects described herein will be set forth in the detailed description which follows, and in part will be readily apparent to those skilled in the art from that description or recognized by practicing the aspects described herein, including the detailed description, the claims, as well as the appended drawings.

It is to be understood that both the foregoing general description and the following detailed description describe various aspects and are intended to provide an overview or framework for understanding the nature and character of the claimed subject matter. The accompanying drawings are included to provide a further understanding of the various aspects, and are incorporated into and constitute a part of this specification. The drawings illustrate the various aspects described herein, and together with the description serve to explain the principles and operations of the claimed subject matter.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A depicts a front view of a first illustrative protective case in closed position according to one or more embodiments shown and described herein;

FIG. 1B depicts a perspective view of the protective case of FIG. 1A in an open position according to one or more embodiments shown and described herein;

FIG. 2A depicts a front view of a second illustrative protective case according to one or more embodiments shown and described herein;

FIG. 2B depicts a front perspective view of the protective case of FIG. 2A;

FIG. 2C depicts a bottom perspective view of the protective case of FIG. 2A;

FIG. 3A depicts a front view of a third illustrative protective case in closed position according to one or more embodiments shown and described herein;

FIG. 3B depicts a perspective view of the protective case of FIG. 3A in an open position according to one or more embodiments shown and described herein;

FIG. 4A depicts a front view of a fourth illustrative protective case in a latched position according to one or more embodiments shown and described herein;

FIG. 4B depicts a perspective view of the protective case of FIG. 4A;

FIG. 4C depicts a bottom perspective view of the protective case of FIG. 4A in an unlatch position according to one or more embodiments shown and described herein;

FIG. 5A depicts a perspective view of a fifth illustrative protective case in an open position according to one or more embodiments shown and described herein;

FIG. 5B depicts a perspective view of the protective case of FIG. 5A in a closed position according to one or more embodiments shown and described herein;

FIG. 6A depicts a perspective view of a sixth illustrative protective case in a disconnected configuration according to one or more embodiments shown and described herein;

FIG. 6B depicts a perspective view of the protective case of FIG. 6A in a connected configuration according to one or more embodiments shown and described herein;

FIG. 7A depicts a front view of a seventh illustrative protective case according to one or more embodiments shown and described herein;

FIG. 7B depicts a side view of the protective case of FIG. 7A;

FIG. 7C depicts a perspective view of the protective case of FIG. 7A;

FIG. 8A depicts a front view of an eighth illustrative protective case according to one or more embodiments shown and described herein;

FIG. 8B depicts a side view of the protective case of FIG. 8A;

FIG. 9A depicts a perspective view of a ninth illustrative protective case in a closed position according to one or more embodiments shown and described herein;

FIG. 9B depicts a perspective view of the protective case of FIG. 9A in an open position according to one or more embodiments shown and described herein;

FIG. 9C depicts an interior view of the protective case of FIG. 9A;

FIG. 9D depicts an illustrative accessory retaining clip according to one or more embodiments shown and described herein;

FIG. 10A depicts a perspective view of a tenth illustrative protective case in a closed position according to one or more embodiments shown and described herein;

FIG. 10B depicts a perspective view of the protective case of FIG. 10A in an open position according to one or more embodiments shown and described herein;

FIG. 11 depicts a perspective view of an eleventh illustrative protective case according to one or more embodiments shown and described herein;

FIG. 12A depicts a perspective view of a twelfth illustrative protective case having a removable protective pouch according to one or more embodiments shown and described herein;

FIG. 12B depicts the protective case of FIG. 12A disposed within the protective pouch according to one or more embodiments shown and described herein;

FIG. 13A schematically depicts a first step in a process of removing a protective pouch from a protective case and placing the protective case within the protective pouch according to one or more embodiments shown and described herein;

FIG. 13B schematically depicts a second step in a process of removing a protective pouch from a protective case and placing the protective case within the protective pouch according to one or more embodiments shown and described herein;

FIG. 13C schematically depicts a third step in a process of removing a protective pouch from a protective case and placing the protective case within the protective pouch according to one or more embodiments shown and described herein;

FIG. 14A schematically depicts a first step in a process of removing a protective cinch sack from a protective case and placing the protective case within the cinch sack according to one or more embodiments shown and described herein;

FIG. 14B schematically depicts a second step in a process of removing a protective cinch sack from a protective case and placing the protective case within the cinch sack according to one or more embodiments shown and described herein;

FIG. 14C schematically depicts a third step in a process of removing a protective cinch sack from a protective case and placing the protective case within the cinch sack according to one or more embodiments shown and described herein;

FIG. 15A depicts a front perspective view of a thirteenth illustrative protective case having a headband cover according to one or more embodiments shown and described herein;

FIG. 15B depicts a rear perspective view of the protective case of FIG. 15A;

FIG. 15C depicts a partial side view of the protective case of FIG. 15A depicting an illustrative arrangement of the headband cover according to one or more embodiments shown and described herein;

FIG. 16A depicts a perspective view of a fourteenth illustrative protective case according to one or more embodiments shown and described herein;

FIG. 16B depicts a bottom view of the protective case of FIG. 16A depicting a charging/data port cover disposed in a closed position according to one or more embodiments shown and described herein; and

FIG. 16C depicts a detailed bottom view of the protective case of FIGS. 16A and 16B depicting the charging/data port cover in an open position and exposing a charging/data port according to one or more embodiments shown and described herein.

### DETAILED DESCRIPTION

The present disclosure generally relates to various protective cases for electronic devices, particularly over-the-ear headphones, other related accessories, and/or similar devices. The protective cases herein generally cover at least a portion of the electronic device (including up to the entirety of the electronic device) and may include one or more other features for retaining the electronic device within the case. In some embodiments, the protective cases may include one or more additional features, including, but not limited to, charging/data ports, magnetic switches, additional storage pouches, locking components, security straps, shoulder straps, access ports, impact resistant features, water resistant/water-proof features, dust sealing features, and/or coupling features for coupling to other devices, bags, cases, or the like. In some embodiments, the protective cases described herein may have components for coupling one or more accessories thereto, such as, for example, a wallet accessory, a stand accessory, a key ring accessory, a clip accessory, a carabiner accessory, a trinket accessory, a supplemental battery pack, a solar panel, travel adaptors, cables, or the like. Various embodiments of the protective cases will be described in greater detail herein.

As noted above, the protective cases described herein can be used for any electronic device, although for the purposes of brevity, the protective cases described herein are generally described with respect to headphones, such as over-the-ear type and on-the-ear type headphones. However, throughout the disclosure, it should be understood that the term “headphones” is meant to encompass any electronic device without limitation. Illustrative other electronic devices include a pager, a personal digital assistant (PDA), a music player, a cellphone, a smart phone, a tablet, a laptop, an e-reader, headphones, earbuds, an electronic accessory, or the like. Electronic devices according to the present disclosure may include one or more buttons, switches (e.g., a sliding switch, such as a muting switch, a flip top switch, and/or the like), charging components, ports, headbands, and/or the like. As will be described herein, an electronic device may be positioned within the protective case and held by the protective case. The protective case may provide a protective and/or a waterproof housing around the electronic device. However, the present disclosure is not limited to only protective cases and/or waterproof cases. That is, a “protective case” as used herein is generally any apparatus that can be configured to surround at least a portion of the electronic device, including, for example, a bumper case, a device frame, a sleeve, or the like.

In addition to the foregoing, it should also be understood that while the present disclosure relates to protective cases for over-the-ear type or on-the-ear type headphones having a headband, a pair of ear cups coupled to the headband, and drivers disposed within the ear cups, the present disclosure is not restricted to only such headphones. That is, other headphones that include other features, alternative features, additional features, and/or fewer features are included within the scope of the present application without limitation. For example, the headphones may be earbud type headphones, bone conduction type headphones, wired headphones, wireless headphones, hearing aid or cochlear implant accessories, aviation headsets, and/or the like. In some embodiments, the headphones described herein may further include a microphone, such as a boom mounted microphone or the like. In some embodiments, the headphones described herein may have an adjustable headband. In some embodiments, the headphones described herein may have a single ear cup and driver disposed on one end of the headband and a head pad disposed on another end of the headband. Other features of headphones should generally be understood. Illustrative examples of headphones that may be used with the protective cases described herein include, but are not limited to AirPods Max® headphones manufactured by Apple Inc. (Cupertino, Calif.), Beats® headphones manufactured by Beats Electronics LLC (Culver City, Calif.), Soundlink® headphones manufactured by Bose Corporation (Framingham, Mass.), or the like.

It should be understood that various features discussed herein with respect to certain embodiments are not limited to only the embodiment in which such features appear. That is, certain features may be present in any of the embodiments described herein, even if the present disclosure does not explicitly recite that the embodiment includes such features. In addition, it should be understood that the embodiments described herein are not required to have the features described for that particular embodiment, and may have fewer, additional, or alternative features without departing from the scope of the present disclosure. Further, the embodiments described herein are merely illustrative examples and are not meant to encompass all of the embodiments recited in the claims.

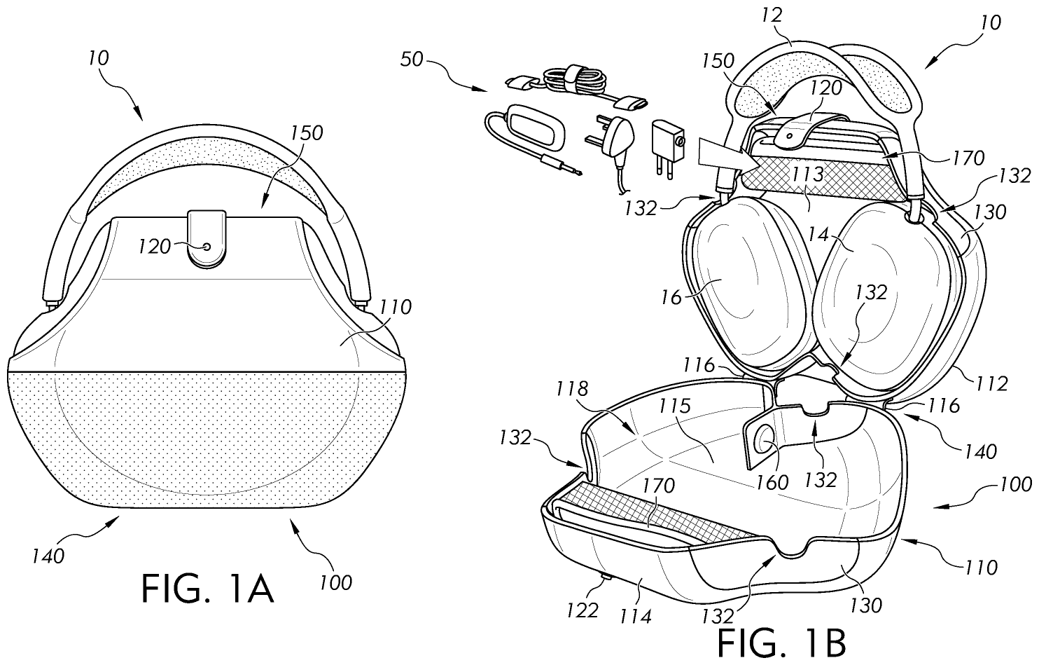

Referring now to FIGS. 1A-1B, an embodiment of a protective case 100 for holding headphones 10, such as over-the-ear headphones, is generally depicted. The protective case 100 generally includes a body 110. The body 110 includes a first portion 112 and a second portion 114 that are hingedly joined together on one end via one or more hinges 116 (e.g., nylon hinges or the like) to form a cavity 118 for holding the headphones 10 or a portion thereof. That is, when the first portion 112 and the second portion 114 are closed together to enclose the cavity 118 as depicted in FIG. 1A, the body 110 may be considered to be in a closed configuration. In addition, when the first portion and the second portion 114 are opened so as to expose the cavity as depicted in FIG. 1B, the body 110 may be considered to be in an open configuration.

Still referring to FIGS. 1A-1B, the body 110 includes a base 140 and a top 150. In some embodiments, the base 140 of the body 110 may be substantially planar when the body 110 is arranged in the closed configuration such that the base 140 can support the protective case 100 in an upright position. In some embodiments, the one or more hinges 116 may be disposed at the base 140 of the body. In some embodiments, a retention piece 120 may be disposed at the top 150 of the body. The retention piece 120 may hold the body in the closed configuration in some embodiments. That is, the retention piece 120 may be a clasp, latch, snap, lock, or the like. In some embodiments, the retention piece 120 may extend from one of the first portion 112 or the second portion 114 of the body 110 towards the other of the first portion 112 or the second portion 114 of the body 110. When the body is moved into the closed configuration as depicted in FIG. 1A, the retention piece 120 may engage with a catch 122 or the like to hold the body 110 in the closed configuration. The catch 122 may be any component that can engage with the retention piece 120, such as a protrusion, an indentation, a hook, a magnet, and/or the like. In one illustrative example, the retention piece 120 may be a silicone latch. In another illustrative example, the retention piece 120 may have a magnet integrated thereon or therewith, and may hold the first portion 112 and the second portion 114 together. In yet another illustrative example, the retention piece 120 may be a sliding lock whereby the respective shapes of the first portion 112 and the second portion 114 at the top 150 of the body 110 are particularly shaped so that when the retention piece 120 is slid in a first direction, the retention piece 120 engages with the first portion 112 and the second portion 114 to hold the first portion 112 and the second portion 114 together. When the retention piece 120 is slid in a second direction opposite the first direction, the retention piece 120 disengages with the first portion 112 and the second portion 114 such that the first portion 112 and the second portion 114 can be separated from one another. In some embodiments, the retention piece 120 may be omitted. In such embodiments, the first portion 112 and the second portion 114 may include locking components (e.g., interlocking edges, magnets, or the like) that hold the first portion 112 and the second portion 114 together in the closed configuration. In some embodiments, the retention piece 120 may be lockable (e.g., via a keyed lock, a combination style lock, a biometric style lock).

In some embodiments, the first portion 112 and the second portion 114 may be shaped, sized, and/or configured such that, when joined together, the cavity 118 formed therefrom is particularly shaped, sized, and/or configured to conform to a particular type of headphones (or a portion thereof) or to hold a variety of different headphone shapes, sizes, and styles. For example, the cavity 118 may hold at least a first ear cup 14 and a second ear cup 16 of the headphones 10 and may or may not be particularly shaped, sized, and configured to hold a particular shape and size of ear cups 14, 16. Put another way, the cavity 118 may be particularly shaped, sized, and/or contoured to fit a particular type of headphones (or portion thereof) or may be more generally shaped, sized, and/or contoured to hold a variety of different headphone types (or portions thereof). The cavity 118 may be defined by walls of the first portion 112 and the second portion 114. For example, the first portion 112 may include one or more interior walls 113 thereof and the second portion 114 may include one or more interior walls 115 thereof that define the cavity 118 when the first portion 112 and the second portion 114 are joined together.

In some embodiments, the body 110 may be a hard shell body that is formed of an impact resistant or impact absorbing material. In some embodiments, the body 110 may be particularly shaped and/or sized to correspond to a shape and/or size of a portion of the headphones 10 received therein. In some embodiments, the body 110 may be constructed of a soft material that conforms to the shape of the headphones 10 when the headphones 10 are received within the cavity 118. In still other embodiments, the body 110 may be formed of a combination of hard and soft components. For example, the body 110 may include one or more flexible side panels 130 thereon (e.g., side panels 130 constructed of polychloroprene or the like). Such flexible side panels 130 may be shaped as a pocket in some embodiments to provide additional storage.

In some embodiments, the first portion 112 and/or the second portion 114 of the body 110 may include one or more wall features 132 therein such that, when the first portion 112 and the second portion 114 are joined together to form the cavity 118, the wall features 132 define openings into the cavity 118. In some embodiments, the wall features 132 may be sized, shaped, and/or located such that one or more portions of the headphones 10 (e.g., a headband 12 thereof) extend through the openings when the first portion 112 and the second portion 114 are joined together. That is, the wall features 132 may form apertures through the walls of the body 110 to allow the headband 12 to extend therethrough. As a result, as depicted in the embodiment of FIGS. 1A and 1B, the headphones 10 are arranged with respect to the protective case 100 such that the first ear cup 14 and the second ear cup 16 are disposed inside the cavity 118 and the headband 12 extends outside of the cavity 118. In some embodiments, the wall features 132 may be located as part of the flexible side panels 130 such that the material of the flexible side panels 130 deforms around a portion of the headphones 10 when the headphones 10 are received within the cavity 118 to provide a snug fit when the first portion 112 and the second portion 114 are joined together to enclose at least a portion of the headphones 10 (e.g., the ear cups 14, 16 thereof) within the cavity 118.

In some embodiments, one or more interior walls 113 of the first portion 112 and/or one or more interior walls 115 the second portion 114 may be lined with a material that prevents or minimizes the headphones 10 from becoming scratched, chipped, marred, or the like when received within the cavity 118 (e.g., velvet, felt, or the like). Still further, one or more of the first portion 112 and/or the second portion 114 may be lined with or constructed from a padded material (e.g., foam or the like) or other impact absorbing material to protect portions of the headphones 10 received in the cavity 118 during an impact (e.g., when dropped or the like).

In some embodiments, the one or more internal walls 160 may be formed within the cavity 118, such as, for example, as an extension of the one or more walls of the first portion 112 and/or the second portion 114. In some embodiments, the one or more internal walls 160 may be particularly shaped, sized, and/or positioned to ensure appropriate placement of the headphones 10 within the cavity 118. For example, the one or more internal walls 160 may be used to ensure that various portions of the headphones 10, such as the first and second ear cups 14, 16 and/or the headband 12 are particularly positioned and aligned within the cavity 118 such that the first and second portions 112, 114 can be moved into the closed position around at least a portion of the headphones 10 (e.g., the first and second ear cups 14, 16).

In some embodiments, the one or more internal walls 160 may include various components therein for ensuring that the headphones are actuated, switched off, placed in a power save mode, charged, and/or the like. For example, the one or more internal walls 160 may include one or more magnets formed therein. The one or more magnets may align with a magnetic switch within the headphones 10 (not shown) for actuating one or more headphone features (e.g., shutting off the headphones 10, placing the headphones 10 in a power save mode, and/or the like). That is, the body 110 may be formed with one or more receptacles or the like for which a magnet may be inserted such that magnetic forces from the magnet are generally directed inward or outward to facilitate placement of an object and/or for retaining an object. In some embodiments, the material of the body 110 may be formed of a magnetic material. That is, the entire body 110 may be formed of a magnetic material or a portion of the body 110 (e.g., an area of the body at, near, and/or surrounding the retention piece 120) is formed of a magnetic material. Examples of suitable magnetic materials (e.g., various ferromagnetic materials) should generally be understood. In another example, the one or more internal walls 160 may include a wireless charging component that aligns with wireless charging components of the headphones 10 and allows for wireless charging of the headphones 10 when received and appropriately positioned within the cavity 118. Such charging may be achieved via a charging cable coupled to the protective case 100, a battery, a solar panel, and/or a wireless charging pad included within the protective case 100 as described herein.

In some embodiments, one or more walls (including, but not limited to, the one or more interior walls 113, 115 and/or the one or more internal walls 160) within the cavity 118 may be arranged and/or contain features that define one or more storage areas 170, such as internal pockets, dividers, storage cubbies, or the like. For example, the storage areas 170 may be one or more mesh pockets formed on an interior wall of the first portion 112 and/or the second portion 114 for holding one or more accessories 50 (e.g., charging cables, docks, power adaptors, audio cables, splitters, airplane accessories, and the like) therein. Such storage areas 170 may be located in existing spaces between areas within the cavity 118, additional spaces formed in or near the cavity 118, or the like. The one or more storage areas 170 may be fixed or removable from the protective case 100. In some embodiments, the one or more storage areas 170 may be opened or closed via a closure mechanism that is separate from or integrated with the retention piece 120. For example, a storage area 170 may be closed via a zipper, buttons, snaps, an interlocking sealing mechanism, or the like. In some embodiments, the storage area 170 may be a battery enclosure for holding a battery that is electrically coupled to the headphones 10 when the headphones 10 are received within the cavity 118 and configured to charge the headphones 10 when received within the cavity 118.

In some embodiments, one or more walls (e.g., the interior walls 113 of the first portion 112, the interior walls 115 of the second portion 114, and/or the internal walls 160) may have one or more surface features such as, for example, recesses, grooves, indentations, protrusions, flanges, detents, threads, and/or the like that, when contacted or otherwise engaged with an object, may interface with the object and hold the object within the cavity 118. For example, the walls may hold the headphones 10, the one or more storage areas 170, and/or the like.

While not depicted, the body 110 may have one or more sensors integrated therein. The one or more sensors may provide data that is used to provide additional functionality to the headphones 10. For example, one or more sensors may be used to sense when the headphones 10 are inserted within the cavity 118 so that additional actions can be completed (e.g., activate charging or the like). In another example, the one or more sensors may be integrated with a radio, such as a global positioning satellite (GPS) radio, a near field communication (NFC) radio, a Bluetooth® radio, a wife radio, and/or the like that may provide communications for various purposes, such as, for example, determining a location of the protective case 100 and/or the headphones 10 therein in the event that they are lost.

It should now be appreciated that the protective case 100 depicted in FIGS. 1A-1B can be particularly formed to hold the headphones 10 therein in such a manner that the headphones 10 can be maintained, transported, or the like in such a manner that minimizes or avoids damage to the headphones 10. Further, the protective case 100 depicted in FIGS. 1A-1B allows for a user to hold the headband 12 of the headphones while the protective case 100 surrounds and protects the remainder of the headphones 10 (e.g., the ear cups 14, 16). That is, the protective case 100 allows for the headband 12 of the headphones 10 to serve dual purposes (e.g., holding the ear cups 14, 16 on a user's head when in use and serving as a handle when in the protective case 100).

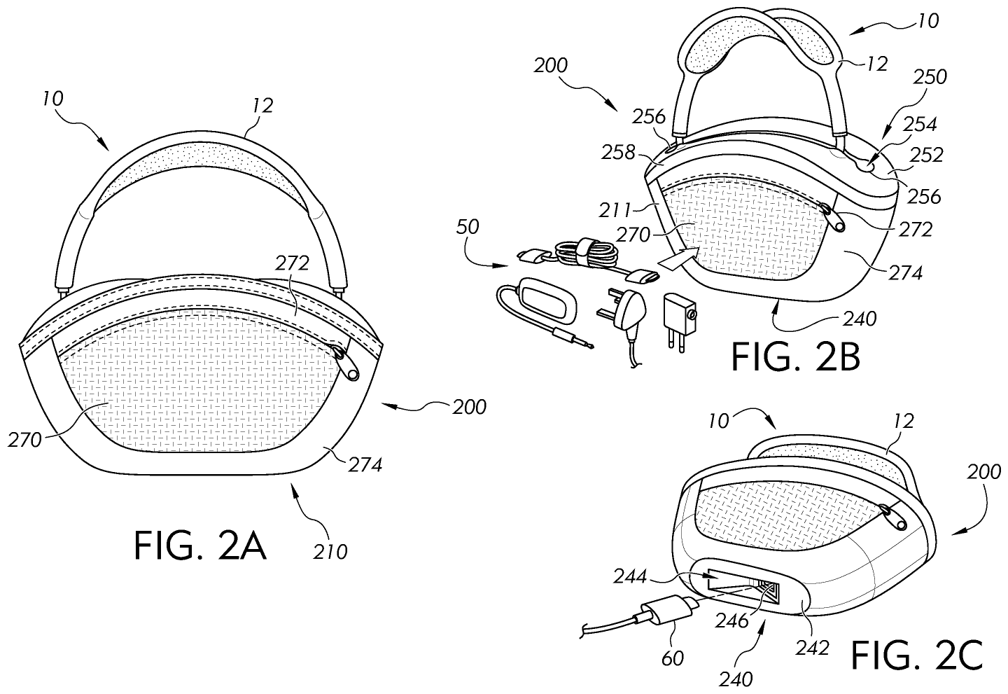

FIGS. 2A-2C depict another embodiment of a protective case 200. As shown in FIGS. 2A-2C, the protective case 200 includes a body 210 thereof that is a single piece component having a top insertion aperture 254 therein for inserting a portion of the headphones 10 therein, while leaving the headband 12 of the headphones 10 exposed. In some embodiments, the headband 12 of the headphones 10 may be used as a carrying handle.

In some embodiments, the body 210 may be a hard shell body that is formed of an impact resistant or impact absorbing material. In some embodiments, the body 210 may be particularly shaped and/or sized to correspond to a shape and/or size of a portion of the headphones 10 received therein. In some embodiments, the body 210 may be constructed of a soft material that conforms to the shape of the headphones 10 when the headphones 10 are received therein. In still other embodiments, the body 210 may be formed of a combination of hard and soft components.

The body 210 of the protective case 200 further defines a cavity (not shown) for holding the headphones 10 therein, particularly the ear cups 14, 16 thereof (not shown). The cavity may be particularly shaped, sized, and/or contoured to fit a particular type of headphones 10 or may be more generally shaped, sized, and/or contoured to hold a variety of different headphone types. The cavity may be defined by walls of the body 210. The top insertion aperture 254 may provide an opening into the cavity for receiving the ear cups 14, 16, as described in further detail herein. In some embodiments, one or more interior walls of the body 210 may be lined with a soft material, such as velvet or the like, to prevent the headphones 10 from becoming scratched, chipped, marred, or the like when received within the cavity.

As particularly shown in the embodiment of FIG. 2B, a top 250 of the body 210 of the protective case 200 may include a top surface 252 having a top insertion aperture 254 formed therein. The top insertion aperture 254 generally provides access to the interior of the protective case 200 (e.g., the cavity, not shown in FIGS. 2A-2C). The top insertion aperture 254 may generally be shaped, sized, and configured such that the ear cups 14, 16 (FIG. 1B) of the headphones 10 can pass into the interior of the protective case 200. That is, the top surface 252 is formed of a material that is elastic or otherwise deformable. Accordingly, the top surface 252 allows the ear cups 14, 16 (FIG. 1B) of the headphones 10 to displace the deformable material (e.g., push aside) when being inserted. Once the ear cups 14, 16 (FIG. 1B) are inserted into the interior of the protective case 200, the deformable material of the top surface 252 moves back into place to restrain the ear cups 14, 16 (FIG. 1B) of the headphones 10 within the cavity while the headband 12 portion thereof extends out of the protective case 200 and can be usable as a carrying handle or the like. In some embodiments, the top insertion aperture 254 may have shaped portions 256 that are generally sized and/or located such that the headband 12 of the headphones 10 extends through the top insertion aperture 254 at the shaped portions 256 and the deformable material of the top surface 252 compresses around the headband 12 at the shaped portions 256, acting as a collar or the like. In some embodiments, the elastic or otherwise deformable material of the top surface 252 may be spandex, polychloroprene, or other similar flexible material. In some embodiments, a trim webbing 258 may extend along an edge of one or more side walls 211 of the body 210 to bind the deformable material of the top surface 252 to the one or more side walls 211 of the body 210.

Referring particularly to FIG. 2C, the protective case 200 may include one or more features for accessing, charging, and/or actuating the headphones 10 when the headphones are received within the protective case 200 (e.g., within the cavity, not shown in FIG. 2C). For example, in some embodiments, a base 240 of the body 210 may include a base wall 242 having an aperture 244 therein, such as an access port, recess, or the like. The aperture 244 may be shaped and sized to allow certain ones of the accessories 50 (FIG. 2B) to be passed through the base wall 242 into the interior of the protective case. For example, the aperture 244 may be shaped and sized such that a charging cable 60 can pass through the base wall 242 and couple to a charging/data port on the headphones 10 when the headphones 10 are received within the protective case 200. In some embodiments, the aperture 244 may include a charging/data port 246 therein. Such a charging/data port 246 may be electrically coupled to the headphones 10 when the headphones are placed within the protective case 200 (e.g., via a conductive charging pad or the like). As such, when power is supplied to the charging/data port 246 (e.g., via a cable 60 that is inserted into the charging/data port 246), charging capabilities are provided by the protective case 200 to the headphones 10 when the headphones 10 are received within the protective case 200. In addition or in the alternative, the charging/data port 246 may be electrically coupled to a battery integrated within the protective case to charge the battery, which is then used to charge the headphones 10 when received within the protective case 200 as described herein.

As depicted in FIGS. 2A-2C, the body 210 of the protective case 200 may include one or more external pockets 270 located on an external surface 274 of the body 210 in some embodiments. Such external pockets 270 may provide additional place for storing the one or more accessories 50 described herein. In some embodiments, the external pockets 270 may have a closure 272, such as a zipper or the like. The external pockets 270 may be formed of a flexible material in some embodiments such that the external pockets 270 can expand to increase the volume thereof when necessary.

While not depicted in FIGS. 2A-2C, one or more internal walls may be formed within the cavity. In some embodiments, the one or more internal walls may be particularly shaped, sized, and positioned to ensure appropriate placement of the headphones 10 within the cavity (e.g., to ensure that the protective case 200 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 210 may have one or more surface features such as recesses, grooves, indentations, protrusions, flanges, detents, threads, and/or the like that, when contacted or otherwise engaged with an object, may interface with the object and hold the object within the cavity.

While not depicted, the body 210 may have one or more sensors and/or radios embedded therein that are used for the purposes of sensing and/or external communication, as described herein.

It should be appreciated that the protective case 200 depicted in FIGS. 2A-2C does not have a first portion hingedly coupled to a second portion to provide access to an interior of the protective case 200. Rather, access to the interior of the protective case is provided via the deformable material of the top surface 252 and the top insertion aperture 254.

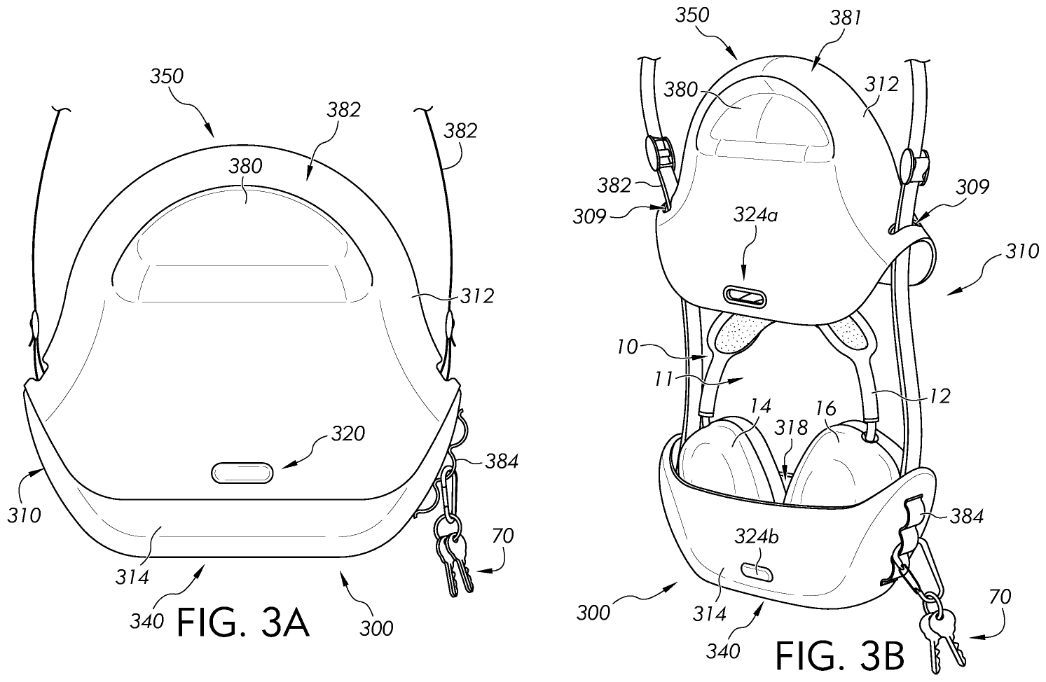

Referring now to FIGS. 3A-3B, another embodiment of a protective case 300 is depicted. For the purposes of brevity, some features of the protective case 300 of FIGS. 3A-3B that are similar to those of the protective case 100 depicted in FIGS. 1A-1B and/or the protective case 200 depicted in FIGS. 2A-2C may not be discussed in further detail. Rather, it should be understood that certain features described herein with respect to FIGS. 1A-1B and/or FIGS. 2A-2C may also be included as part of the protective case 300 depicted in FIGS. 3A-3B.

As depicted in the embodiment of FIGS. 3A-3B, the protective case 300 generally includes a body 310. The body 310 includes a first portion 312 and a second portion 314 that are joinable together to define a cavity 318 that receives the headphones 10 such that the headphones 10 are encased within the body 310. The cavity 318 may be particularly shaped, sized, and/or contoured to fit a particular type of headphones 10 or may be more generally shaped, sized, and/or contoured to hold a variety of different headphone types. The first portion 312 and the second portion 314 are shaped and configured such that the first portion 312 and the second portion 314 are completely separable from one another to expose a cavity 318 for holding the headphones 10 therein, and can be joined together to contain the headphones 10 once received within the cavity 318. For example, one of the first portion 312 or the second portion 314 slips overtop the other of the first portion 312 or the second portion 314 to join the first portion 312 and the second portion 314 together. In another example, the first portion 312 and the second portion 314 each include an interlocking portion that allows for the first portion 312 and the second portion 314 to be joined together. In yet another example, a closure device such as a zipper, a snap, or the like, may be disposed on one or both of the first portion 312 and the second portion 314 to hold the first portion 312 and the second portion 314 together For example, the body 310 may include a retention piece 320 (e.g., a female portion 324a of the retention piece 320 disposed on one of the first portion or the second portion 314 and a corresponding male portion 324b of the retention piece 320 disposed on the other of the first portion 312 or the second portion 314, the male portion 324b and the female portion 324a joinable together to hold the first portion 312 and the second portion 314 together). In some embodiments, the retention piece 320 may be a molded latch, lock, or the like. In some embodiments, the retention piece 320 may have a magnet integrated thereon or therewith, and may hold the first portion 312 and the second portion 314 together. In some embodiments, the retention piece 320 may be lockable (e.g., via a keyed lock, a combination style lock, a biometric style lock).

In some embodiments, the body 310 may be a hard shell body that is formed of an impact resistant or impact absorbing material. In some embodiments, the body 310 may be particularly shaped and/or sized to correspond to a shape and/or size of a portion of the headphones 10 received therein. In some embodiments, the body 310 may be constructed of a soft material that conforms to the shape of the headphones 10 when the headphones 10 are received therein. In still other embodiments, the body 310 may be formed of a combination of hard and soft components. For example, the body 310 may include one or more polychloroprene side panels thereon, which may be shaped as a pocket in some embodiments to provide additional storage.

In some embodiments, the walls of the first portion 312 and/or the second portion 314 may have one or more surface features such as recesses, grooves, indentations, protrusions, flanges, detents, threads, and/or the like that, when contacted or otherwise engaged with an object (e.g., the headphones 10, the other one of the first portion 312 and the second portion 314), may interface with the object and hold the object. For example, the body 310 may have a recessed portion 380 disposed at or near the top 350 of the body 310. The recessed portion 380 may be shaped and/or sized to correspond to a gap 11 (FIG. 3B) between the headband 12 and the ear cups 14, 16 of the headphones 10. When the first portion 312 and the second portion 314 are joined together around the headphones 10, the body 310 may initially flex to press the headband 12 into a storage portion 381 disposed between the recessed portion 380 and the top 350 of the body and then may move back into an initial shape whereby the recessed portion 380 is disposed within the gap 11, thereby holding the headphones 10 in place with respect to the body 310 of the protective case 300. In addition, the recessed portion 380 may act as a grip surface for carrying the protective case 300 and may optionally contain a relatively higher friction material disposed thereon or integrated therewith to facilitate gripping by a user.

In some embodiments, the body 310 of the protective case 300 may have one or more attachment features 384 extending from the body 310 and providing a point of fixture or attachment of an accessory 70. For example, the one or more attachment features 384 may include one or more protrusions, bumps, knobs, projections, posts, loops, recesses, apertures, or similar components that are particularly shaped, sized, configured, and/or oriented for the purposes of providing a point on the body 310 of the protective case 300 for fixture or attachment of the accessory 70. For example, as depicted in the embodiment of FIGS. 3A-3B, the one or more attachment features may include one or more loops disposed on an exterior surface of the body 310 that provide an attachment point for a key ring, a carabiner, or the like.

In some embodiments, the protective case 300 may further include a support strap 382 coupled to the body 310 and usable to support the protective case 300. In the embodiment depicted in FIGS. 3A-3B, the support strap 382 may be coupled to portions of the body 310 in such a manner to maintain a connection between the first portion 312 and the second portion 314 when they are separated from one another as described herein. For example, the support strap 382 may be coupled to the second portion 314 at two points to form a loop. In addition, the first portion 312 includes one or more apertures 309 through which the support strap 382 is passed. The apertures 309 may be located so as to not interfere with the joining of the first portion 312 and the second portion 314 as described herein, but at the same time allow the support strap 382 to act as a tether that keeps the first portion 312 and the second portion 314 together when separated from one another to provide access to the cavity 318 as described herein. The support strap 382 may generally be any type of strap, including, but not limited to, a shoulder strap, a backpack-type strap, a waist-worn strap, and the like.

While not depicted, the body 310 may have one or more sensors and/or radios embedded therein that are used for the purposes of sensing and/or external communication, as described herein.

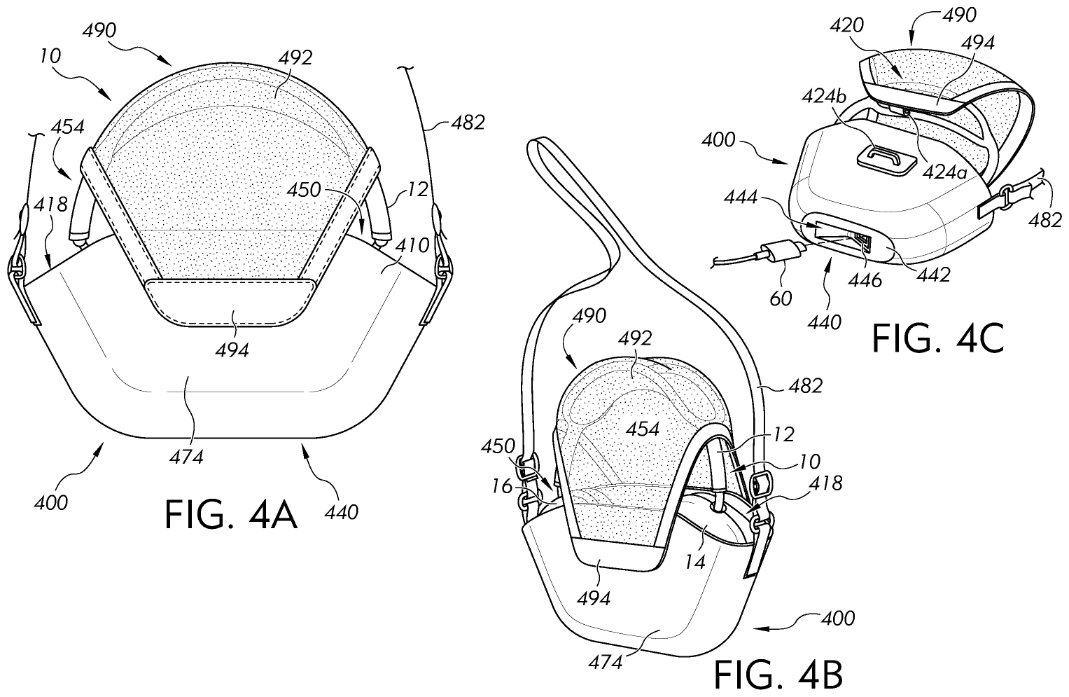

FIGS. 4A-4C depict another embodiment of a protective case 400. As shown in FIGS. 4A-4C, the protective case 400 includes a body 410 thereof that is a single piece component having an open top 454 therein for inserting a portion of the headphones 10 therein, while leaving the headband 12 of the headphones 10 exposed. The protective case 400 further includes a retention strap 490 that extends over at least a portion of the open top 454.

In some embodiments, the body 410 may be a hard shell body that is formed of an impact resistant or impact absorbing material. In some embodiments, the body 410 may be particularly shaped and/or sized to correspond to a shape and/or size of a portion of the headphones 10 received therein. In some embodiments, the body 410 may be constructed of a soft material that conforms to the shape of the headphones 10 when the headphones 10 are received therein. In still other embodiments, the body 410 may be formed of a combination of hard and soft components.

The body 410 of the protective case 400 further defines a cavity 418 for holding the headphones 10 therein, particularly the ear cups 14, 16 thereof (not shown). The cavity 418 may be particularly shaped, sized, and/or contoured to fit a particular type of headphones 10 or may be more generally shaped, sized, and/or contoured to hold a variety of different headphone types. The cavity 418 may be defined by walls of the body 410. The cavity 418 may be open to an exterior of the protective case 400 via the open top 454 to receive the ear cups 14, 16 through the open top 454, as described in further detail herein. In some embodiments, one or more interior walls of the body 410 may be lined with a soft material, such as velvet or the like, to prevent the headphones 10 from becoming scratched, chipped, marred, or the like when received within the cavity.

As particularly shown in the embodiment of FIG. 4B, a top 450 of the body 410 of the protective case 400 may include the open top 454. The open top 454 generally provides access to the interior of the protective case 400 (e.g., the cavity 418). The open top 454 may generally be shaped, sized, and configured such that the ear cups 14, 16 of the headphones 10 can pass into the cavity 418 of the protective case 400. In addition, the body 410 (e.g., the top 450 thereof) may further include the retention strap 490 coupled thereto. The retention strap 490 may be coupled to one surface of the body 410 and may be removably coupled to another surface of the body 410. For example, the retention strap 490 may include a first portion 492 coupled to the body 410 and a second portion 494 located at a distal end of the first portion 492, the second portion 494 having a retention piece 420. As particularly depicted in FIG. 4C, the retention piece 420 may include one or more interlocking portions 424a, 424b that removably couple to one another to hold the second portion 494 of the retention strap 490 in a closed configuration. For example, a first interlocking portion 424a may be coupled to the second portion 494 and a second interlocking portion 424a may be coupled to the body 410 (e.g., a wall 474 of the body 410). The retention piece 420 may include a hook portion and an eye portion (e.g., as shown in FIG. 4C), a fold over locking portion, a toggle portion, a lobster claw portion, a spring ring portion, a box tab insert portion, a fishhook portion, an s hook portion, a barrel portion, opposite magnet portions, hook and loop fastener portions, and/or the like. In some embodiments, the retention piece 420 may be particularly shaped and sized to provide a snug fit for a particular type of headphones within the cavity 418 (e.g., a particular shape of the headband 12). In other embodiments, the retention piece 420 may be formed to accommodate a variety of differently shaped and/or sized headphones 10, such as, for example, by being constructed of a stretchable material that deforms over the headphones 10 and holds the headphones 10 in place within the cavity 418. In some embodiments, the retention piece 420 may be lockable (e.g., via a keyed lock, a combination style lock, a biometric style lock).

Referring particularly to FIG. 4C, the protective case 400 may include one or more features for accessing, charging, and/or actuating the headphones 10 when the headphones 10 are received within the protective case 400 (e.g., within the cavity 418 depicted in FIG. 4B). Still referring to FIG. 4C, in some embodiments, a base 440 of the body 410 may include a base wall 442 having an aperture 444 therein, such as an access port, recess, or the like. The aperture 444 may be shaped and sized to allow certain ones of the accessories 50 (FIG. 1B) to be passed through the base wall 442 into the interior of the protective case 400. For example, the aperture 444 may be shaped and sized such that a charging cable 60 can pass through the base wall 442 and couple to a charging/data port on the headphones 10 when the headphones 10 are received within the protective case 400. In some embodiments, the aperture 444 may include a charging/data port 446 therein. Such a charging/data port 446 may be electrically coupled to the headphones 10 when the headphones are placed within the protective case 400 (e.g., via a conductive charging pad or the like). As such, when power is supplied to the charging/data port 446 (e.g., via a cable 60 that is inserted into the charging/data port 446), charging capabilities are provided by the protective case 400 to the headphones 10 when the headphones 10 are received within the protective case 400. In addition or in the alternative, the charging/data port 446 may be electrically coupled to a battery integrated within the protective case 400 to charge the battery, which is then used to charge the headphones 10 when received within the protective case 400 as described herein.

While not depicted in FIGS. 4A-4C, one or more internal walls may be formed within the cavity 418. In some embodiments, the one or more internal walls may be particularly shaped, sized, and positioned to ensure appropriate placement of the headphones 10 within the cavity 418 (e.g., to ensure that the protective case 400 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 410 may have one or more surface features such as recesses, grooves, indentations, protrusions, flanges, detents, threads, and/or the like that, when contacted or otherwise engaged with an object, may interface with the object and hold the object within the cavity.

While not depicted, the body 510 may have one or more sensors and/or radios embedded therein that are used for the purposes of sensing and/or external communication, as described herein.

As also depicted in FIGS. 4A-4C, the body 410 may also include one or more attachment points for receiving a device that is clipped to the body 410. For example, a strap 482 may be coupled to the body 410 in some embodiments. The strap 482 may be a shoulder strap, a waist strap, a backpack strap, a hanging strap, or the like. Other items that may be attached in a similar manner include, but are not limited to, keys, tracking devices, carabiners, and/or the like.

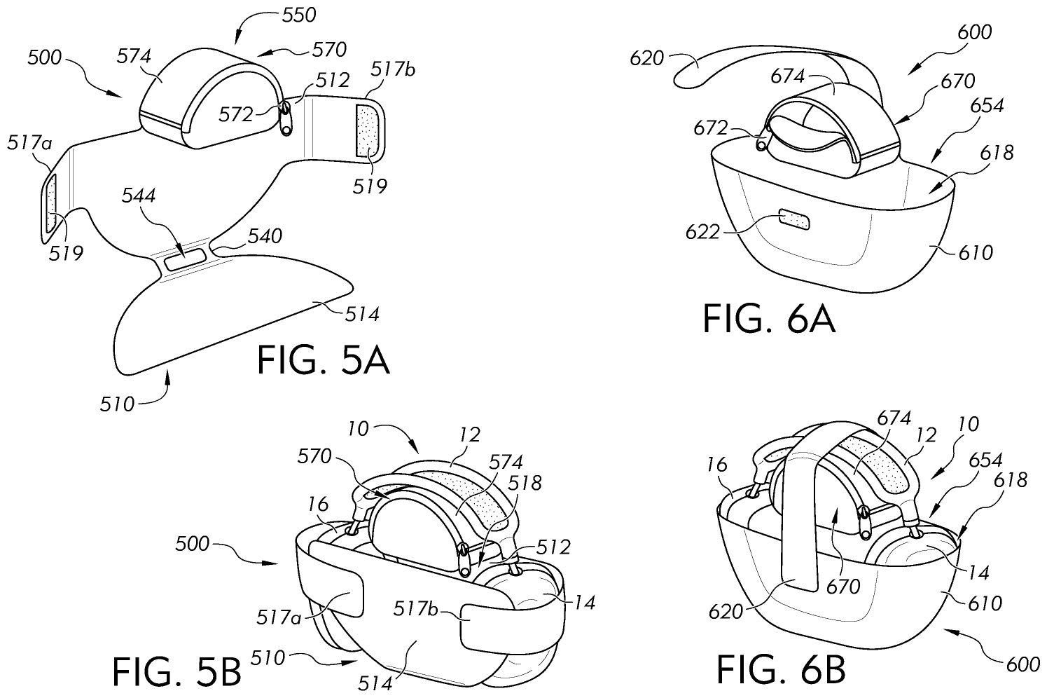

FIGS. 5A-5B depict another embodiment of a protective case 500. As depicted in FIGS. 5A-5B, the protective case 500 generally includes a body 510. The body 510 may be a single piece component that includes a first portion 512, a second portion 514 a first side tab 517a, and a second side tab 517b that can be brought together to form a cavity for holding the headphones 10. The first portion 512 is coupled to the second portion 514 via a base portion 540 and each of the first and second side tabs 517a, 517b extend transversely from either the first portion 512 or the second portion 514 (depicted in FIG. 5A as extending from the first portion 512). The first portion 512 and the second portion 514 are foldable at the respective intersections with the base portion 540 and the first and second side tabs 517a, 517b are foldable around the first or second portions 512, 514 to form a cavity 518 as shown in FIG. 5B to hold the headphones 10 therein. That is, when the first portion 512 the second portion 514, and the side tabs 517a, 517b are brought together to enclose the cavity 518 as depicted in FIG. 5B, the body 510 may be considered to be in a closed configuration. In addition, when the first portion 512, the second portion 514, and the side tabs 517a, 517b are unfolded as depicted in FIG. 5A, the body 510 may be considered to be in an open configuration.

In some embodiments, the base portion 540 of the body 510 may be substantially planar when the body 510 is arranged in the closed configuration such that the base portion 540 can support the protective case 500 in an upright position. In some embodiments, each of the side tabs 517a, 517b may include a retention component 519 that secures each side tab 517a, 517b as described herein. Such retention components 519 may be, for example, a hook portion, an eye portion, a fold over locking portion, a toggle portion, a lobster claw portion, a spring ring portion, a box tab insert portion, a fishhook portion, an s hook portion, a barrel portion, a magnet portion, a hook and loop fastener portion (e.g., as depicted in FIG. 5A), and/or the like.

In some embodiments, the first portion 512, the second portion 514, and the side tabs 517a, 517b may be shaped, sized, and/or configured such that, when joined together, the cavity 518 formed therefrom is particularly shaped, sized, and/or configured to conform to a particular type of headphones (or a portion thereof) or to hold a variety of different headphone shapes, sizes, and styles. For example, as particularly shown in FIG. 5B, the cavity 518 may hold at least a first ear cup 14 and a second ear cup 16 of the headphones 10 and may or may not be particularly shaped, sized, and configured to hold a particular shape and size of ear cups 14, 16. Put another way, the cavity 518 may be particularly shaped, sized, and/or contoured to fit a particular type of headphones (or portion thereof) or may be more generally shaped, sized, and/or contoured to hold a variety of different headphone types (or portions thereof). The cavity 518 may be defined by walls formed by the first portion 512, the second portion 114, and/or the side tabs 517a, 517b.

In some embodiments, the body 510 may be a hard shell body that is formed of an impact resistant or impact absorbing material. In some embodiments, the body 510 may be particularly shaped and/or sized to correspond to a shape and/or size of a portion of the headphones 10 received therein. In some embodiments, the body 510 may be constructed of a soft material that conforms to the shape of the headphones 10 when the headphones 10 are received within the cavity 518. In still other embodiments, the body 510 may be formed of a combination of hard and soft components.

In some embodiments, one or more interior surfaces of the first portion 512, the second portion 514, the base portion 540, and/or the side tabs 517a, 517b may be lined with a material that prevents or minimizes the headphones 10 from becoming scratched, chipped, marred, or the like when received within the cavity 518 (e.g., velvet, felt, or the like). Still further, one or more of the first portion 512, the second portion 514, the base portion 540, and/or the side tabs 517a, 517b may be lined with or constructed from a padded material (e.g., foam or the like) or other impact absorbing material to protect portions of the headphones 10 received in the cavity 518 during an impact (e.g., when dropped or the like).

In some embodiments, a top of the body 510 (e.g., an upper portion of the first portion 512) may include a storage area 570 disposed thereon or integrated therewith. Illustrative examples of the storage area 570 include, but are not limited to, an internal pocket, a divider, a storage cubby, or the like. The storage area 570 is generally located in an existing gap 11 (see e.g., FIG. 3B) disposed between the headband 12 and ear cups 14, 16 of the headphones 10 when the headphones are received within the cavity 518 (e.g., near a top 550 of the body 510). As such, the storage area 570 is shaped and sized to generally confirm to a shape and/or a size of the headband 12 such that the storage area 570 fits within the existing gap 11. For example, storage area 570 may have an upper wall 574 having a curvature that is similar or substantially similar to the curvature of the headband 12 of the headphones 10. The storage area 570 may be fixed or removable from the protective case 500. In some embodiments, the storage area 570 may be opened or closed via a closure mechanism 572. For example, the storage area 570 may be closed via a zipper, buttons, snaps, an interlocking sealing mechanism, or the like. In some embodiments, the storage area 570 may be a battery enclosure for holding a battery that is electrically coupled to the headphones 10 when the headphones 10 are held by the protective case 500 and configured to charge the headphones 10 when held by the protective case. In some embodiments, the storage area 570 may be a solar panel enclosure for holding a solar panel that is electrically coupled to the headphones 10 when the headphones 10 are held by the protective case 500 and configured to charge the headphones 10 when held by the protective case. In some embodiments, the storage area 570 may be a wireless charging enclosure for holding a wireless charging pad that is electrically coupled to the headphones 10 when the headphones 10 are held by the protective case 500 and configured to be placed on an external wireless charger and transmit electrical power to the headphones 10 when held by the protective case.

In some embodiments, the base portion 540 may have an aperture 544 formed therein. The aperture 544 may be shaped and sized to allow an accessory such as a charging cable or the like to be passed through the base portion 540 into the interior of the protective case 500. For example, the aperture 544 may be shaped and sized such that a charging cable can pass through the base portion 540 and couple to a charging/data port on the headphones 10 when the headphones 10 are received within the protective case 500.

FIGS. 6A-6B depict another embodiment of a protective case 600. As shown in FIGS. 6A-6B, the protective case 600 includes a body 610 thereof that is a single piece component having an open top 654 for inserting a portion of the headphones 10 therein, while leaving the headband 12 of the headphones 10 exposed. The protective case 600 further includes a retention piece 620 that extends over at least a portion of the open top 654 and a fixed storage area 670 that sits within the gap 11 (see, e.g., FIG. 3B) between the headband 12 and the ear cups 14, 16, as described hereinbelow.

The body 610 of the protective case is a hard shell body that is formed of an impact resistant or impact absorbing material. In some embodiments, the body 610 may be particularly shaped and/or sized to correspond to a shape and/or size of a portion of the headphones 10 received therein. The hard shell body may be particularly shaped for a particular brand and model of headphones, or may be shaped to accommodate a variety of different headphone shapes and sizes. In some embodiments, the body 610 may incorporate certain soft elements in addition to being a hard shell body (e.g., soft elements are used for storage of accessories or the like).

The body 610 of the protective case 600 further defines a cavity 618 for holding the headphones 10 therein, particularly the ear cups 14, 16 thereof (shown in FIG. 6B). The cavity 618 may be particularly shaped, sized, and/or contoured to fit a particular type of headphones 10 or may be more generally shaped, sized, and/or contoured to hold a variety of different headphone types. The cavity 618 may be defined by walls of the body 610. The cavity 618 may be open to an exterior of the protective case 600 via the open top 654 to receive the ear cups 14, 16 through open top 654, as described in further detail herein. In some embodiments, one or more interior walls of the body 610 may be lined with a soft material, such as velvet or the like, to prevent the headphones 10 from becoming scratched, chipped, marred, or the like when received within the cavity.

The open top 654 generally provides access to the interior of the protective case 600 (e.g., the cavity 618). The open top 654 may generally be shaped, sized, and configured such that the ear cups 14, 16 of the headphones 10 can pass into the cavity 618 of the protective case 600. In addition, the body 610 may further include the retention piece 620 coupled thereto. The retention piece 620 may be coupled to one surface of the body 610 and may be removably coupled to another surface of the body 610. For example, the retention piece 620 may include a first portion coupled to the body 610 (e.g., a backside of the body 610) and a second portion located at a distal end of the first portion, the second portion removably coupled to a catch 622. The catch 622 may be any component that can engage with the retention piece 620, such as a protrusion, an indentation, a hook, a magnet, and/or the like. In one illustrative example, the retention piece 620 may be a silicone latch. In another illustrative example, the retention piece 620 may have a magnet integrated thereon or therewith, and may hold the retention piece 620 to the catch 622. In some embodiments, the retention piece 620 may be lockable (e.g., via a keyed lock, a combination style lock, a biometric style lock).

While not particularly highlighted in FIGS. 6A-6B, one or more internal walls may be formed within the cavity 618. In some embodiments, the one or more internal walls may be particularly shaped, sized, and positioned to ensure appropriate placement of the headphones 10 within the cavity 618 (e.g., to ensure that the protective case 600 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 610 may have one or more surface features such as recesses, grooves, indentations, protrusions, flanges, detents, threads, and/or the like that, when contacted or otherwise engaged with an object, may interface with the object and hold the object within the cavity.

In some embodiments, a top of the body 610 (e.g., an upper portion of the body 610) may include a storage area 670 disposed thereon or integrated therewith. Illustrative examples of the storage area 670 include, but are not limited to, an internal pocket, a divider, a storage cubby, or the like. The storage area 670 is generally located in the existing space disposed between the headband 12 and ear cups 14, 16 of the headphones 10 when the headphones are received within the cavity 618. As such, the storage area 670 is shaped and sized to generally confirm to a shape and/or a size of the headband 12 such that the storage area 670 fits within the existing space. For example, storage area 670 may have an upper wall 674 having a curvature that is similar or substantially similar to the curvature of the headband 12 of the headphones 10. The storage area 670 may be constructed of a rigid material similar to that of the body 610 (e.g., as an extension of the body 610). In some embodiments, certain portions of the storage area 670 (e.g., a cover) may be constructed of a rigid material or a flexible material. In some embodiments, the storage area 670 may be opened or closed via a closure mechanism 672. For example, the storage area 670 may be closed via a zipper, buttons, snaps, an interlocking sealing mechanism, or the like. In some embodiments, the storage area 670 may be a battery enclosure for holding a battery that is electrically coupled to the headphones 10 when the headphones 10 are received within the cavity 618 and configured to charge the headphones 10 when received within the cavity 618. In other embodiments, the storage area 670 may be a solar panel enclosure for holding a solar panel that is electrically coupled to the headphones 10 when the headphones 10 are received within the cavity 618 and configured to charge the headphones 10 when received within the cavity 618. In some embodiments, the storage area 670 may be a wireless charging enclosure for holding a wireless charging pad that is electrically coupled to the headphones 10 when the headphones 10 are held by the protective case 600 and configured to be placed on an external wireless charger and transmit electrical power to the headphones 10 when held by the protective case.

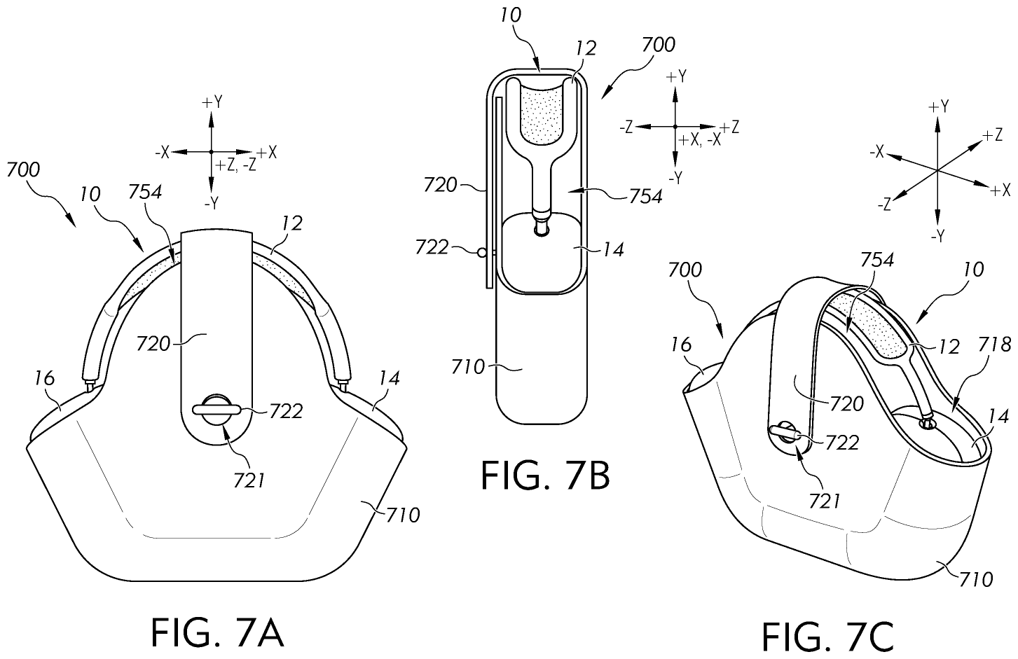

FIGS. 7A-7C depict another embodiment of a protective case 700. As shown in FIGS. 7A-7C, the protective case 700 includes a body 710 thereof that is a single piece component having an open top 754 therein for inserting a portion of the headphones 10 therein. The body 710 generally extends in such a manner so as to minimize an amount of the headphones 10 that is exposed, as described in greater detail below. The protective case 700 further includes a retention piece 720 that extends over at least a portion of the open top 754.

In some embodiments, the body 710 may be a hard shell body that is formed of an impact resistant or impact absorbing material. In some embodiments, the body 710 may be particularly shaped and/or sized to correspond to a shape and/or size of the headphones 10 received therein. That is, the body 710 may extend a distance in a system vertical direction (e.g., in the +y/−y axis of the coordinate axes of FIGS. 7A-7C) so that the body 710 covers a substantial portion of the headphones 10 (including the headband 12 and the ear cups 14, 16), leaving only the tops of the headband 12 and the ear cups 14, 16 exposed by the open top 754 thereof. In some embodiments, the body 710 may be constructed of a soft material that conforms to the shape of the headphones 10 when the headphones 10 are received therein. In still other embodiments, the body 710 may be formed of a combination of hard and soft components.

The body 710 of the protective case 400 further defines a cavity 718 for holding the headphones 10 therein, particularly the ear cups 14, 16 thereof (not shown). The cavity 718 may be particularly shaped, sized, and/or contoured to fit a particular type of headphones 10 or may be more generally shaped, sized, and/or contoured to hold a variety of different headphone types. The cavity 718 may be defined by walls of the body 710. The cavity 718 may be open to an exterior of the protective case 700 via the open top 754 to receive the ear cups 14, 16 through the open top 754, as described in further detail herein. In some embodiments, one or more interior walls of the body 710 may be lined with a soft material, such as velvet or the like, to prevent the headphones 10 from becoming scratched, chipped, marred, or the like when received within the cavity.

The open top 754 generally provides access to the interior of the protective case 700 (e.g., the cavity 718). The open top 754 may generally be shaped, sized, and configured such that the ear cups 14, 16 of the headphones 10 can pass into the cavity 718 of the protective case 700. In some embodiments, the open top 754 may be contoured or shaped to correspond to a contour or shape of the headphones 10 (e.g., such that it matches the profile shape of the headphones 10, as shown in FIGS. 7A-7C). In addition, the body 710 may further include the retention piece 720 coupled thereto. The retention piece 720 may be coupled to one surface of the body 710 and may be removably coupled to another surface of the body 710. For example, the retention piece 720 may include a first portion coupled to the body 710 (e.g., a backside of the body 710) and a second portion located at a distal end of the first portion, the second portion removably couplable to a clasp 722. For example, as shown in FIGS. 7A and 7C, the second portion of the retention piece 720 may have an opening 721 through which the clasp 722 passes to hold the retention piece 720 in place. However, it should be understood that the clasp 722 may be any component that can engage with the retention piece 720, such as a protrusion, an indentation, a hook, a magnet, and/or the like. In another illustrative example, the retention piece 720 may have a magnet integrated thereon or therewith, and may hold the retention piece 720 to the clasp 722. In some embodiments, the retention piece 720 may be lockable (e.g., via a keyed lock, a combination style lock, a biometric style lock).

While not depicted in FIGS. 7A-7C, one or more internal walls may be formed within the cavity 718. In some embodiments, the one or more internal walls may be particularly shaped, sized, and positioned to ensure appropriate placement of the headphones 10 within the cavity 718 (e.g., to ensure that the protective case 700 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 710 may have one or more surface features such as recesses, grooves, indentations, protrusions, flanges, detents, threads, and/or the like that, when contacted or otherwise engaged with an object, may interface with the object and hold the object within the cavity.

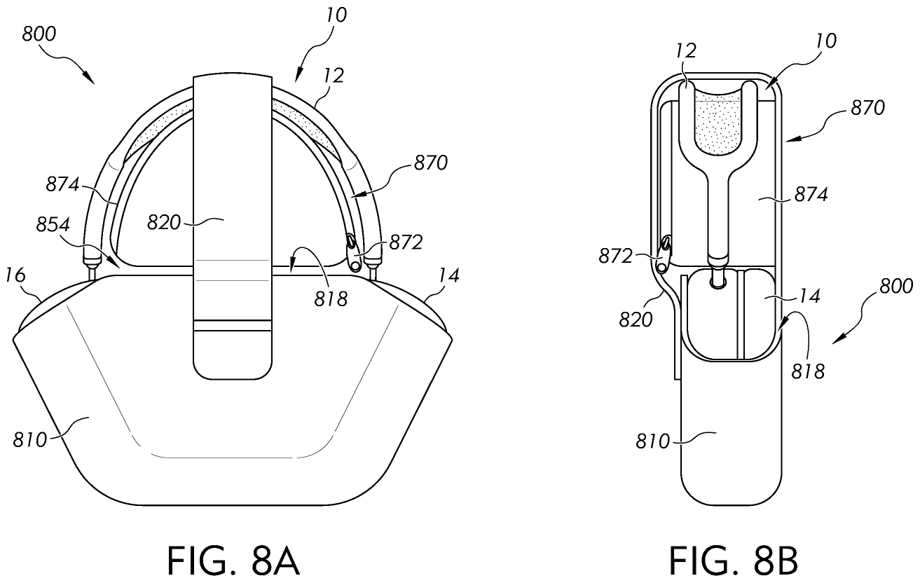

FIGS. 8A-8B depict another embodiment of a protective case 800. As shown in FIGS. 8A-8B, the protective case 800 includes a body 810 thereof that is a single piece component having an open top 854 for inserting a portion of the headphones 10 therein, while leaving the headband 12 of the headphones 10 exposed. The protective case 800 further includes a retention piece 820 that extends over at least a portion of the open top 854.

In some embodiments, the body 810 may be a soft shell body that is formed of a deformable material. In some embodiments, the body 810 may be generally shaped and/or sized to correspond to a shape and/or size of a portion of the headphones 10 received therein. The body 810 of the protective case 800 further defines a cavity 818 for holding the headphones 10 therein, particularly the ear cups 14, 16 thereof. The cavity 818 may be particularly shaped, sized, and/or contoured to fit a particular type of headphones 10 or may be more generally shaped, sized, and/or contoured to hold a variety of different headphone types. The cavity 818 may be defined by walls of the body 810. The cavity 818 may be open to an exterior of the protective case 800 via the open top 854 to receive the ear cups 14, 16 through open top 854, as described in further detail herein. In some embodiments, one or more interior walls of the body 810 may be lined with a soft material, such as velvet or the like, to prevent the headphones 10 from becoming scratched, chipped, marred, or the like when received within the cavity.

The open top 854 generally provides access to the interior of the protective case 800 (e.g., the cavity 818). The open top 854 may generally be shaped, sized, and configured such that the ear cups 14, 16 of the headphones 10 can pass into the cavity 818 of the protective case 800. In addition, the body 810 may further include the retention piece 820 coupled thereto. The retention piece 820 may be coupled to one surface of the body 810 and may be removably coupled to another surface of the body 810. For example, the retention piece 820 may include a first portion coupled to the body 810 (e.g., a backside of the body 810) and a second portion located at a distal end of the first portion, the second portion removably couplable to the body 810 (e.g., a front side of the body 810). For example, the second portion of the retention piece 820 and the body 810 may each have complementary portions of a hook and loop attachment patch. In another illustrative example, the retention piece 820 and/or the body 810 may have a magnet integrated thereon or therewith, and may hold the retention piece 820 to the body 810. In some embodiments, the retention piece 820 may be lockable (e.g., via a keyed lock, a combination style lock, a biometric style lock).

While not particularly highlighted in FIGS. 8A-8B, one or more internal walls may be formed within the cavity 818. In some embodiments, the one or more internal walls may be particularly shaped, sized, and positioned to ensure appropriate placement of the headphones 10 within the cavity 818 (e.g., to ensure that the protective case 800 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 810 may have one or more surface features such as recesses, grooves, indentations, protrusions, flanges, detents, threads, and/or the like that, when contacted or otherwise engaged with an object, may interface with the object and hold the object within the cavity.

In some embodiments, a top of the body 810 (e.g., an upper portion of the body 810) may include a removable storage area 870 disposed thereon. Illustrative examples of the removable storage area 870 include, but are not limited to, an internal pocket, a divider, a storage cubby, or the like. The removable storage area 870 can generally be placed in an existing space disposed between the headband 12 and ear cups 14, 16 of the headphones 10 when the headphones are received within the cavity 818. As such, the removable storage area 870 is shaped and sized to generally conform to a shape and/or a size of the headband 12 such that the removable storage area 870 fits within the existing space. For example, the removable storage area 870 may have an upper wall 874 having a curvature that is similar or substantially similar to the curvature of the headband 12 of the headphones 10. The removable storage area 870 may be removable from the protective case 800 via one or more means of temporary fixture to the body 810. For example, the removable storage area 870 and the body 810 may each have complementary portions of a hook and loop attachment patch. In another illustrative example, the removable storage area 870 and/or the body 810 may have a magnet integrated thereon or therewith, and may hold the removable storage area 870 to the body 810. In some embodiments, the removable storage area 870 may be opened or closed via a closure mechanism 872. For example, the removable storage area 870 may be closed via a zipper, buttons, snaps, an interlocking sealing mechanism, or the like. In some embodiments, the storage area 870 may be a battery enclosure for holding a battery that is electrically coupled to the headphones 10 when the headphones 10 are received within the cavity 818 and configured to charge the headphones 10 when received within the cavity 818. In some embodiments, the storage area 870 may be a solar panel enclosure for holding a solar panel that is electrically coupled to the headphones 10 when the headphones 10 are received within the cavity 818 and configured to charge the headphones 10 when received within the cavity 818. In some embodiments, the storage area 870 may be a wireless charging enclosure for holding a wireless charging pad that is electrically coupled to the headphones 10 when the headphones 10 are held by the protective case 800 and configured to be placed on an external wireless charger and transmit electrical power to the headphones 10 when held by the protective case.

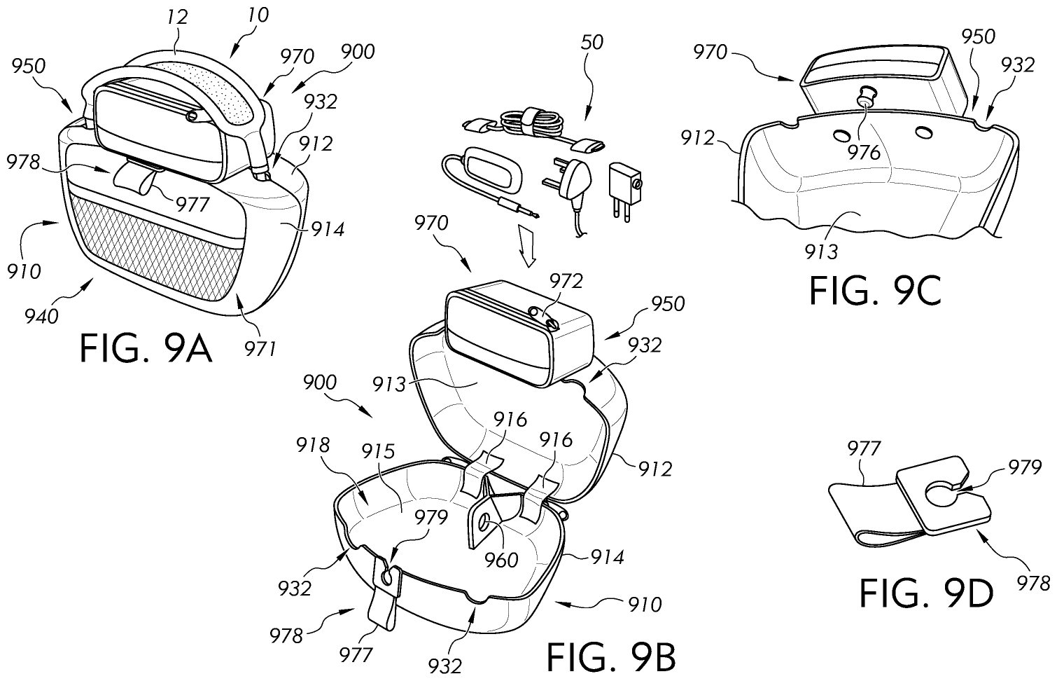

FIGS. 9A-9D depict another embodiment of a protective case 900. Referring to FIGS. 9A-9B, the protective case 900 generally includes a body 910. The body 910 includes a first portion 912 and a second portion 914 that are hingedly joined together on one end via one or more hinges 916 to form a cavity 918 for holding the headphones (not shown) or a portion thereof. That is, when the first portion 912 and the second portion 914 are closed together to enclose the cavity 918 as depicted in FIG. 9A, the body 910 may be considered to be in a closed configuration. In addition, when the first portion and the second portion 914 are opened so as to expose the cavity as depicted in FIG. 9B, the body 910 may be considered to be in an open configuration. In some embodiments, the first portion 912 and the second portion 914 may include locking components (e.g., interlocking edges, magnets, or the like) that hold the first portion 912 and the second portion 914 together in the closed configuration.

Still referring to FIGS. 9A and 9B, the body 910 includes a base 940 and a top 950. In some embodiments, the base 940 of the body 910 may be substantially planar when the body 910 is arranged in the closed configuration such that the base 940 can support the protective case 900 in an upright position. In some embodiments, the one or more hinges 916 may be disposed at the base 940 of the body 910.

In some embodiments, the first portion 912 and the second portion 914 may be shaped, sized, and/or configured such that, when joined together, the cavity 918 formed therefrom is particularly shaped, sized, and/or configured to conform to a particular type of headphones (or a portion thereof) or to hold a variety of different headphone shapes, sizes, and styles. For example, the cavity 918 may hold the ear cups of the headphones and may or may not be particularly shaped, sized, and configured to hold a particular shape and size of ear cups. Put another way, the cavity 918 may be particularly shaped, sized, and/or contoured to fit a particular type of headphones (or portion thereof) or may be more generally shaped, sized, and/or contoured to hold a variety of different headphone types (or portions thereof). The cavity 918 may be defined by walls of the first portion 912 and the second portion 914. For example, the first portion 912 may include one or more interior walls 913 thereof and the second portion 914 may include one or more interior walls 915 thereof that define the cavity 918 when the first portion 912 and the second portion 914 are joined together.

In some embodiments, the body 910 may be a hard shell body that is formed of an impact resistant or impact absorbing material. In some embodiments, the body 910 may be particularly shaped and/or sized to correspond to a shape and/or size of a portion of the headphones received therein. In some embodiments, the body 910 may be constructed of a soft material that conforms to the shape of the headphones when the headphones are received within the cavity 918. In still other embodiments, the body 910 may be formed of a combination of hard and soft components. For example, the body 910 may include one or more flexible side panels (not shown) thereon. Such flexible side panels may be shaped as a pocket in some embodiments to provide additional storage.

In some embodiments, the first portion 912 and/or the second portion 914 of the body 910 may include one or more wall features 932 therein such that, when the first portion 912 and the second portion 914 are joined together to form the cavity 918, the wall features 932 define openings into the cavity 918. In some embodiments, the wall features 932 may be sized, shaped, and/or located such that one or more portions of the headphones (e.g., a headband thereof) extend through the openings when the first portion 912 and the second portion 914 are joined together (e.g., the first portion 912 and the second portion 914 are joined around the headband). As a result, the headphones are arranged with respect to the protective case 900 such that the ear cups are disposed inside the cavity 918 and the headband extends outside of the cavity 918. In some embodiments, the wall features 932 may be located as part of flexible side panels such that the material of the flexible side panels deforms around a portion of the headphones when the headphones are received within the cavity 918 to provide a snug fit when the first portion 912 and the second portion 914 are joined together to enclose at least a portion of the headphones within the cavity 918.

In some embodiments, one or more interior walls 913 of the first portion 912 and/or one or more interior walls 915 of the second portion 914 may be lined with a material that prevents or minimizes the headphones from becoming scratched, chipped, marred, or the like when received within the cavity 918 (e.g., velvet, felt, or the like). Still further, one or more of the first portion 912 and/or the second portion 914 may be lined with or constructed from a padded material (e.g., foam or the like) or other impact absorbing material to protect portions of the headphones received in the cavity 918 during an impact (e.g., when dropped or the like).

In some embodiments, the one or more internal walls 960 may be formed within the cavity 918, such as, for example, as an extension of the one or more walls of the first portion 912 and/or the second portion 914. In some embodiments, the one or more internal walls 960 may be particularly shaped, sized, and/or positioned to ensure appropriate placement of the headphones within the cavity 918. For example, the one or more internal walls 960 may be used to ensure that various portions of the headphones, such as the ear cups and/or the headband are particularly positioned and aligned within the cavity 918 such that the first and second portions 912, 914 can be moved into the closed position around at least a portion of the headphones (e.g., the ear cups).

In some embodiments, the one or more internal walls 960 may include various components therein for ensuring that the headphones are actuated, switched off, placed in a power save mode, charged, and/or the like. For example, the one or more internal walls 960 may include one or more magnets formed therein. The one or more magnets may align with a magnetic switch within the headphones (not shown) for actuating one or more headphone features (e.g., shutting off the headphones, placing the headphones in a power save mode, and/or the like). That is, the body 910 may be formed with one or more receptacles or the like for which a magnet may be inserted such that magnetic forces from the magnet are generally directed inward or outward to facilitate placement of an object and/or for retaining an object. In some embodiments, the material of the body 910 may be formed of a magnetic material. That is, the entire body 910 may be formed of a magnetic material or a portion of the body 910 is formed of a magnetic material. Examples of suitable magnetic materials (e.g., various ferromagnetic materials) should generally be understood. In another example, the one or more internal walls 960 may include a wireless charging component that aligns with wireless charging components of the headphones and allows for wireless charging of the headphones when received and appropriately positioned within the cavity 918.

In some embodiments, one or more walls of the body 910 (including interior walls and exterior walls) may be arranged and/or contain features that define one or more storage areas 971, such as pockets, dividers, storage cubbies, or the like. For example, the storage areas 971 may be one or more mesh pockets formed on an exterior wall of the first portion 912 and/or the second portion 914 for holding one or more accessories 50 (e.g., charging cables, docks, power adaptors, audio cables, splitters, airplane accessories, and the like) therein.

The protective case 900 may be coupled to an external removable storage pocket 970 in some embodiments. The removable storage pocket 970 may generally be a component that is coupled externally to the body 910 of the protective case 900 and is shaped and sized to hold the one or more accessories 50 therein. In some embodiments, the removable storage pocket 970 may have a closure 972, such as a zipper or the like. The removable storage pocket 970 may be formed of a flexible material in some embodiments such that the removable storage pocket 970 can expand to increase the volume thereof when necessary.

The removable storage pocket 970 is removable from the protective case 900. That is, the removable storage pocket 970 may have one or more components, features, or the like that facilitates attachment and removal to/from the protective case 900. For example, as depicted in the embodiments of FIGS. 9C and 9D, the removable storage pocket 970 may include a protrusion 976 extending from a body of the removable storage pocket 970. The protrusion 976 can engage with a receptacle 979 of a retention device 978. As such, the protrusion 976 is shaped and sized such that engagement can be achieved with the receptacle 979 of the retention device 978. In the embodiment depicted in FIGS. 9B-9D, the retention device 978 is an insert that is received within a wall of the second portion 914 of the body 910 of the protective case 900. Alternatively, the retention device 978 may be a receptacle formed within the body 910 of the protective case 900. Still further, the retention device 978 may be a tab that is restrained by the first portion 912 and the second portion 914 of the body 910 when the first portion 912 and the second portion 914 are brought together in the closed position, as described herein. Even further, while FIG. 9B depicts the retention device 978 as being integrated with or disposed on the second portion 914 of the body 910, the present disclosure is not limited to such a location. That is, the retention device 978 may be integrated with or disposed on the first portion 912 of the body 910, or may be partially integrated with or disposed on both the first portion 912 and the second portion 914 of the body in other embodiments. In another example, the retention device 978 may be a specialized one of the one or more wall features 932 that is particularly shaped and/or sized to retain the protrusion 976 therein. In some embodiments, the retention device 978 may further include a loop 977 extending therefrom. The loop 977 may be a decorative tag having indicia thereon and/or may be used as an attachment point for one or more accessories, such as a carabiner or the like. It should be appreciated that the protrusion 976 of the removable storage pocket 970 and the corresponding receptacle 979 of the retention device 978 depicted in FIGS. 9A-9D is merely one illustrative example of components for removably attaching the removable storage pocket 970 to the body 910 of the protective case 900. That is, other removable attachment components, such as hook and loop devices, adhesives, and/or the like, may also be implemented without departing from the scope of the present disclosure.

The location of the removable storage pocket 970 with respect to the body 910 of the protective case is not limited by the present disclosure. In some embodiments, such as the embodiment depicted in FIGS. 9A-9C, the removable storage pocket 970 may be located in a space between formed between the body 910 of the protective case 900 and the headband 12 of the headphones 10 (FIG. 9A). As such, one or more surfaces of the removable storage pocket 970 may be contoured or shaped to correspond to a contour or a shape of the headband 12. In some embodiments, the removable storage pocket 970 may be opened or closed via a closure mechanism. For example, the removable storage pocket 970 may be closed via a zipper, buttons, snaps, an interlocking sealing mechanism, or the like.

In some embodiments, the removable storage pocket 970 may be an enclosure for holding a battery, a solar panel, and/or a wireless charging pad that is electrically coupled to the headphones 10 when the headphones 10 are received within the cavity 918 and configured to charge the headphones 10 when received within the cavity 918. For example, the battery, the solar panel, and/or the wireless charging pad may be electrically coupled to a terminal located on the one or more internal walls 960 and may provide an electrical charge to the headphones 10 when the charging port of the headphones contacts the charging terminal on the one or more internal walls 960.

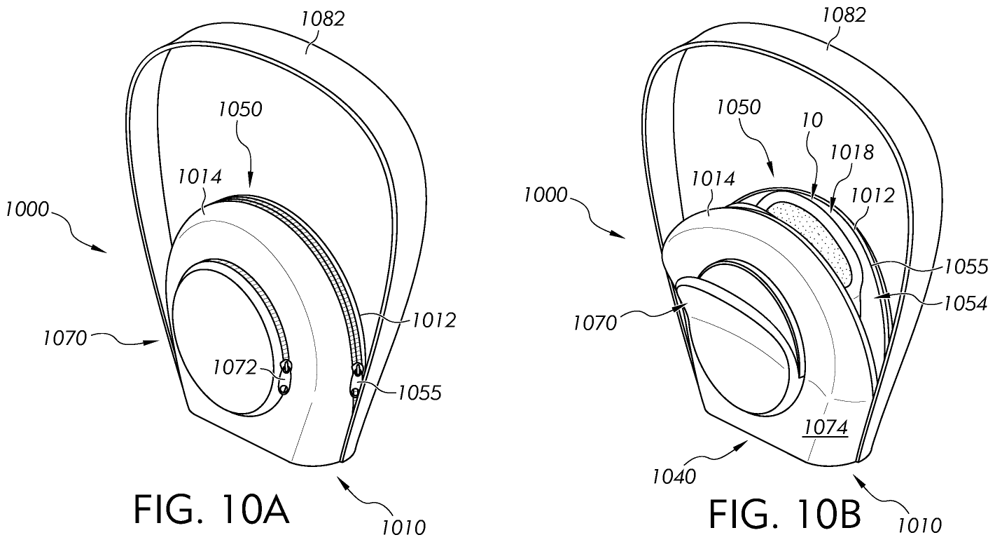

FIGS. 10A-10B depict another embodiment of a protective case 1000. As shown in FIGS. 10A-10B, the protective case 1000 includes a body 1010 thereof that is a single piece component having a top insertion aperture 1054 therein for inserting at least a portion of the headphones 10 therein. In some embodiments, the body 1010 may be a hard shell body that is formed of an impact resistant or impact absorbing material. In some embodiments, the body 1010 may be particularly shaped and/or sized to correspond to a shape and/or size of a portion of the headphones 10 received therein. In some embodiments, the body 1010 may be constructed of a soft material that conforms to the shape of the headphones 10 when the headphones 10 are received therein. In still other embodiments, the body 1010 may be formed of a combination of hard and soft components.

The body 1010 of the protective case 1000 further defines a cavity 1018 for holding the headphones 10 therein, particularly the ear cups thereof (not shown). The cavity 1018 may be particularly shaped, sized, and/or contoured to fit a particular type of headphones 10 or may be more generally shaped, sized, and/or contoured to hold a variety of different headphone types. The cavity 1018 may be defined by walls of the body 1010. The top insertion aperture 1054, which may be defined by a first portion 1012 and a second portion 1014 of the body 1010 for example, may provide an opening into the cavity 1018 for receiving the ear cups, as described in further detail herein. In some embodiments, one or more interior walls of the body 1010 may be lined with a soft material, such as velvet or the like, to prevent the headphones 10 from becoming scratched, chipped, marred, or the like when received within the cavity.

Still referring to FIGS. 10A-10B, the body 1010 includes a base 1040 and a top 1050. In some embodiments, the base 1040 of the body 1010 may be substantially planar such that the base 1040 can support the protective case 1000 in an upright position. As particularly shown in the embodiment of FIG. 10B, the top 1050 of the body 1010 of the protective case 1000 may include the top insertion aperture 1054 formed therein. The top insertion aperture 1054 generally provides access to the interior of the protective case 1000 (e.g., the cavity 1018). The top insertion aperture 1054 may generally be shaped, sized, and configured such that the headphones 10 can pass into the interior of the protective case 1000. In addition, the top insertion aperture 1054 may be closed via a closure 1055 (e.g., a zipper, interlocking members, and/or the like). As such, the top insertion aperture 1054 can be selectively opened and closed via manipulation of the closure 1055.

As depicted in FIGS. 10A-10B, the body 1010 of the protective case 1000 may include one or more external pockets 1070 located on an external surface 1074 of the body 1010 in some embodiments. Such external pockets 1070 may provide additional place for storing the one or more accessories described herein. In some embodiments, the external pockets 1070 may have a closure 1072, such as a zipper or the like. The external pockets 1070 may be formed of a flexible material in some embodiments such that the external pockets 1070 can expand to increase the volume thereof when necessary. In some embodiments, the external pockets 1070 may incorporate other components, such as, for example, a battery pack, a solar panel, and/or a wireless charging pad for charging the headphones 10 when received in the cavity 1018.

As also depicted in FIGS. 10A-10B, the body 1010 may also include one or more attachment points for receiving a device that is clipped to the body 1010. For example, a strap 1082 may be coupled to the body 1010 in some embodiments. The strap 1082 may be a shoulder strap, a waist strap, a backpack strap, a hanging strap, or the like. Other items that may be attached in a similar manner include, but are not limited to, keys, tracking devices, carabiners, and/or the like.

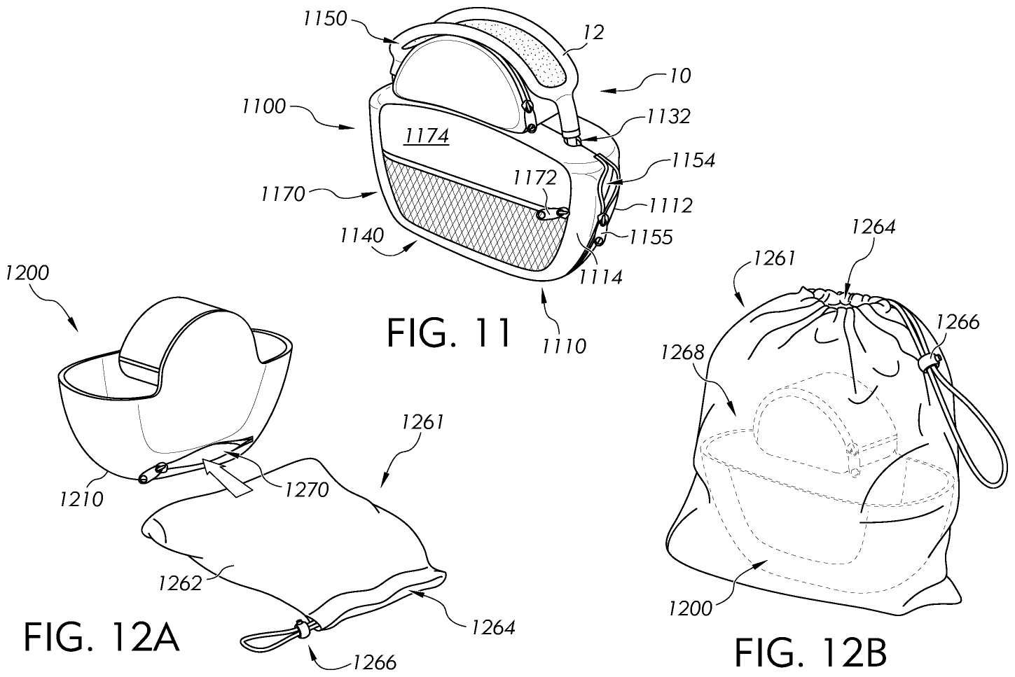

Similar to the protective case 1000 FIGS. 10A-10B, FIG. 11 also depicts an embodiment of a protective case 1100 having an insertion aperture for accessing an interior portion of the protective case 1100, albeit in a different location. As shown in FIG. 11, the protective case 1100 includes a body 1110 thereof having a first portion 1112 and a second portion 1112 that are separable to define a bottom insertion aperture 1154 for inserting at least a portion of the headphones 10 therein. In some embodiments, the body 1110 may be a hard shell body that is formed of an impact resistant or impact absorbing material. In some embodiments, the body 1110 may be particularly shaped and/or sized to correspond to a shape and/or size of a portion of the headphones 10 received therein. In some embodiments, the body 1110 may be constructed of a soft material that conforms to the shape of the headphones 10 when the headphones 10 are received therein. In still other embodiments, the body 1110 may be formed of a combination of hard and soft components.

The body 1110 of the protective case 1100 further defines a cavity (not shown) for holding the headphones 10 therein, particularly the ear cups thereof (not shown). The cavity may be particularly shaped, sized, and/or contoured to fit a particular type of headphones 10 or may be more generally shaped, sized, and/or contoured to hold a variety of different headphone types. The cavity may be defined by walls of the body 1110. The bottom insertion aperture 1154 may provide an opening into the cavity for receiving the ear cups, as described in further detail herein. In some embodiments, one or more interior walls of the body 1110 may be lined with a soft material, such as velvet or the like, to prevent the headphones 10 from becoming scratched, chipped, marred, or the like when received within the cavity.

A base 1140 (or bottom) of the body 1110 of the protective case 1100 may include the bottom insertion aperture 1154 formed therein. The bottom insertion aperture 1154 generally provides access to the interior of the protective case 1100 (e.g., the cavity). The bottom insertion aperture 1154 may generally be shaped, sized, and configured such that the headphones 10 can pass into the interior of the protective case 1100. In addition, the bottom insertion aperture 1154 may be closed via a closure 1155 (e.g., a zipper, interlocking members, and/or the like). As such, the bottom insertion aperture 1154 can be selectively opened and closed via manipulation of the closure 1155.

As depicted in FIG. 11, the body 1110 of the protective case 1100 may include one or more external pockets 1170 located on an external surface 1174 of the body 1110 in some embodiments. Such external pockets 1170 may provide additional place for storing the one or more accessories described herein. In some embodiments, the external pockets 1170 may have a closure 1172, such as a zipper or the like. In some embodiments, the external pockets 1170 may be formed of a flexible material in some embodiments such that the external pockets 1170 can expand to increase the volume thereof when necessary.

In some embodiments, the body 1110 may include one or more wall features 1132 therein that define openings into the cavity. In some embodiments, the wall features 1132 may be sized, shaped, and/or located such that one or more portions of the headphones 10 (e.g., a headband 12 thereof) extend through the openings. The wall features 1132 may be located, for example at ends of the bottom insertion aperture 1154 and/or flexible in size such that portions of the headphones 10 that are held within the protective case 1100 (e.g., the ear cups) can be passed through the wall features 1132 As a result, as depicted in the embodiment of FIG. 11, the headphones 10 are arranged with respect to the protective case 1100 such that the ear cups (not shown) are disposed inside the cavity and the headband 12 extends outside of the cavity.

FIGS. 12A-12B depict another embodiment of the protective case 1200. The protective case 1200 includes a body 1210 having a pocket 1270. The pocket 1270 may provide storage for a supplemental pouch 1261. The supplemental pouch 1261 may be received within the pocket 1270 when not in use and removed from the pocket 1270 when used. In some embodiments, the pocket 1270 may have a closure, such as a zipper or the like. In some embodiments, the pocket 1270 may be formed of a flexible material in some embodiments such that the pocket 1270 can expand to increase the volume thereof when necessary.

The supplemental pouch 1261 may be removable from the pocket 1270 and can be used for a variety of purposes. For example, the supplemental pouch 1261 may have a body 1262 constructed of a waterproof or water resistant material such that when objects are placed in an interior 1268 of the supplemental pouch 1261 (e.g., the protective case 1200 as depicted in FIG. 12B), the supplemental pouch 1261 may keep the contents dry. The interior 1268 of the supplemental pouch 1261 may be accessible via an opening 1264 in the body 1262, which may be selectively closed via a closure 1266 (e.g., a cinch strap, a zipper, interlocking members, and the like).

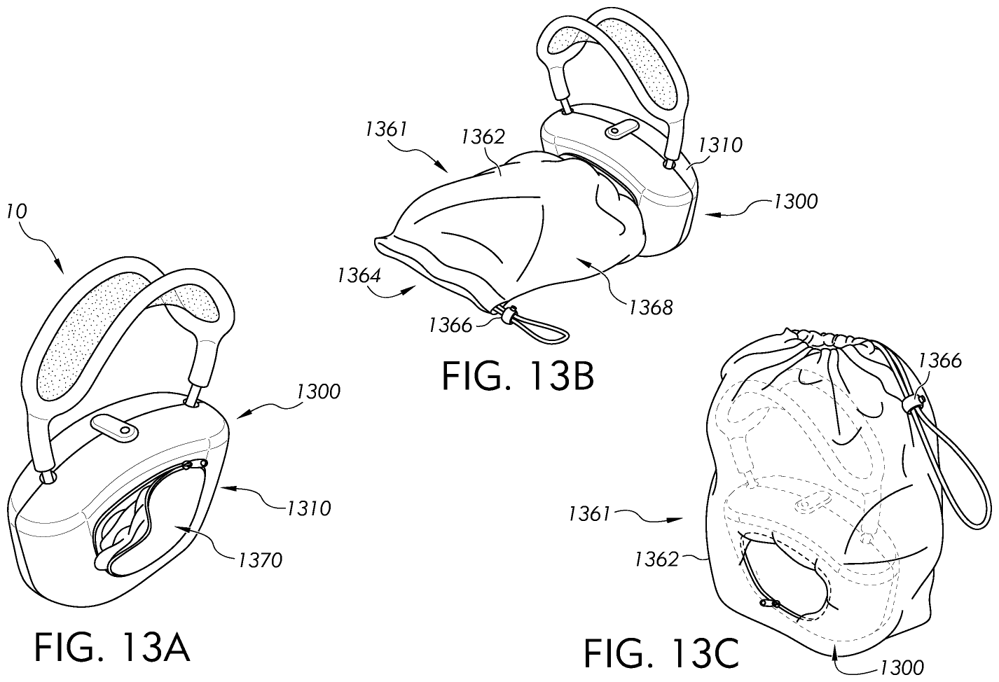

FIGS. 13A-13C depict another embodiment of the protective case 1300. The protective case 1300 includes a body 1310 having a side pocket 1370. The side pocket 1370 may provide storage for a supplemental pouch 1361. The supplemental pouch 1361 may be received within the side pocket 1370 when not in use and removed from the pocket 1370 when used. In some embodiments, the side pocket 1370 may have a closure, such as a zipper or the like. In some embodiments, the pocket 1370 may be formed of a flexible material in some embodiments such that the pocket 1370 can expand to increase the volume thereof when necessary.

The supplemental pouch 1361 may be at least partially removable from the pocket 1370 and can be used for a variety of purposes. For example, the supplemental pouch 1361 may have a body 1362 constructed of a waterproof or water resistant material such that when objects are placed in an interior 1368 of the supplemental pouch 1361 (e.g., the protective case 1300), the supplemental pouch 1361 may keep the contents dry. The interior 1368 of the supplemental pouch 1361 may be accessible via an opening 1364 in the body 1362, which may be selectively closed via a closure 1366 (e.g., a cinch strap, a zipper, interlocking members, and the like).

In some embodiments, the supplemental pouch 1361 may be integrated with the pocket 1370 and may further act as a cover for the side pocket 1370 whereby, when the supplemental pouch 1361 is coupled to the side pocket 1370 (e.g., via buttons, snaps, a zipper, interlocking mechanism, or the like), the supplemental pouch 1361 covers the opening into the side pocket 1370. In some embodiments, the supplemental pouch 1361 may only be partially removable from the pocket 1370 such that the body 1310 of the protective case 1300 remains coupled to the supplemental pouch 1361 when the supplemental pouch 1361 is used. For example, the supplemental pouch 1361 may be partially pulled out of the pocket 1370 and turned inside out around the protective case 1300, while remaining coupled to the pocket 1370, as shown in FIG. 13B for example.

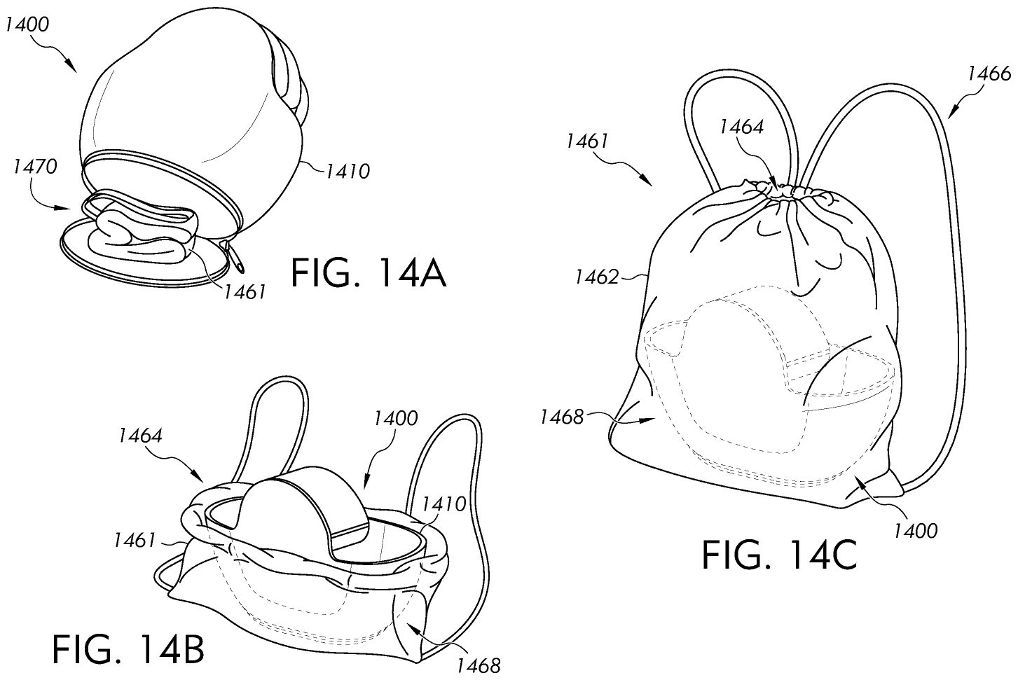

FIGS. 14A-14C depict another embodiment of the protective case 1400. The protective case 1400 includes a body 1410 having a pocket 1470. The pocket 1470 may provide storage for a cinch sack 1461. The cinch sack 1461 may be received within the pocket 1470 when not in use and removed from the pocket 1470 when used. In some embodiments, the pocket 1470 may have a closure, such as a zipper or the like. In some embodiments, the pocket 1470 may be formed of a flexible material in some embodiments such that the pocket 1470 can expand to increase the volume thereof when necessary.

The cinch sack 1461 may be removable from the pocket 1470 and can be used for a variety of purposes. For example, the cinch sack 1461 may have a body 1462 constructed of a waterproof or water resistant material such that when objects are placed in an interior 1468 of the cinch sack 1461 (e.g., the protective case 1400), the cinch sack 1461 may keep the contents dry. The interior 1468 of the cinch sack 1461 may be accessible via an opening 1464 in the body 1462, which may be selectively closed via a closure 1466 (e.g., a cinch strap, a zipper, interlocking members, and the like), which, in the embodiment depicted in FIGS. 14A-14C, may also be used as straps so that the cinch sack 1461 can be worn similar to that of a backpack.

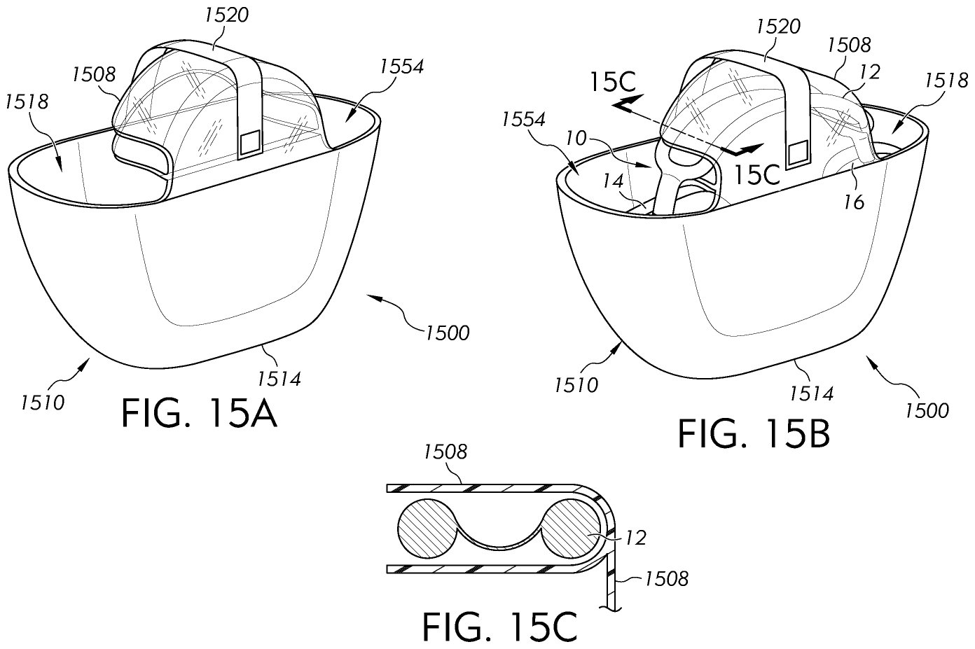

FIGS. 15A-15C depict another embodiment of a protective case 1500. As shown in FIGS. 15A-15C the protective case 1500 includes a body 1510 thereof that is a single piece component having an open top 1554 therein for inserting a portion of the headphones 10 therein. The protective case 1500 further includes a protective extension piece 1508 extending from a main portion 1514 and a retention piece 1520 that extends over at least a portion of the open top 1554.

In some embodiments, the body 1510 may be a hard shell body that is formed of an impact resistant or impact absorbing material. In some embodiments, the body 1510 may be particularly shaped and/or sized to correspond to a shape and/or size of a portion of the headphones 10 received therein. In some embodiments, the body 1510 may be constructed of a soft material that conforms to the shape of the headphones 10 when the headphones 10 are received therein. In still other embodiments, the body 1510 may be formed of a combination of hard and soft components.

The body 1510 of the protective case 1500 further defines a cavity 1518 for holding the headphones 10 therein, particularly the ear cups 14, 16 thereof (not shown). The cavity 1518 may be particularly shaped, sized, and/or contoured to fit a particular type of headphones 10 or may be more generally shaped, sized, and/or contoured to hold a variety of different headphone types. The cavity 1518 may be defined by walls of the body 1510. The cavity 1518 may be open to an exterior of the protective case 1500 via the open top 1554 to receive the ear cups 14, 16 through the open top 1554, as described in further detail herein. In some embodiments, one or more interior walls of the body 1510 may be lined with a soft material, such as velvet or the like, to prevent the headphones 10 from becoming scratched, chipped, marred, or the like when received within the cavity.

The open top 1554 generally provides access to the interior of the protective case 1500 (e.g., the cavity 1518). The open top 1554 may generally be shaped, sized, and configured such that the ear cups 14, 16 of the headphones 10 can pass into the cavity 1518 of the protective case 1500. In addition, the body 1510 (e.g., a main portion 1514 thereof) may further include the protective extension piece 1508 and/or the retention piece 1520 coupled thereto. The protective extension piece 1508 is generally a portion of the body 1510 that extends over the headband 12 of the headphones 10 when the ear cups 14, 16 thereof are received in the cavity 1518 (e.g., as depicted in FIG. 15C). The protective extension piece 1508 may be made of a material that protects the headband 12 from becoming scratched, chipped, marred, or the like. In some embodiments, the protective extension piece 1508 may have one or more closures, such as snaps, zippers, or the like, that allow the protective extension piece to be closed around the headband 12. The retention piece 1520 may be coupled to one surface of the body 1510 and may be removably coupled to another surface of the body 1510. For example, the retention piece 1520 may include a first portion coupled to the body 1510 (e.g., a backside of the body 1510 and/or the protective extension piece 1508) and a second portion located at a distal end of the first portion, the second portion removably couplable to a catch (not shown). The catch may be any component that can engage with the retention piece 1520, such as a protrusion, an indentation, a hook, a magnet, and/or the like. In one illustrative example, the retention piece 1520 may be a silicone latch. In another illustrative example, the retention piece 1520 may have a magnet integrated thereon or therewith, and may hold the retention piece 1520 to the catch. In some embodiments, the retention piece 1520 may be lockable (e.g., via a keyed lock, a combination style lock, a biometric style lock).

While not depicted in FIGS. 15A-15C, one or more internal walls may be formed within the cavity 1518. In some embodiments, the one or more internal walls may be particularly shaped, sized, and positioned to ensure appropriate placement of the headphones 10 within the cavity 1518 (e.g., to ensure that the protective case 1500 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 1510 may have one or more surface features such as recesses, grooves, indentations, protrusions, flanges, detents, threads, and/or the like that, when contacted or otherwise engaged with an object, may interface with the object and hold the object within the cavity.

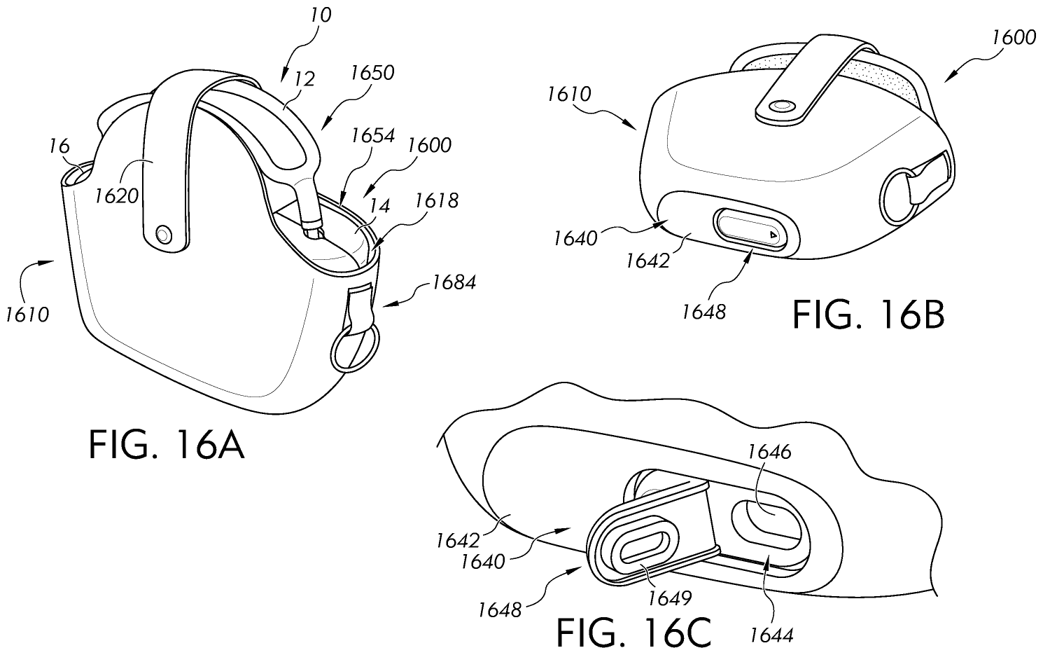

FIGS. 16A-16C depict another embodiment of a protective case 1600. As shown in FIGS. 16A-16C the protective case 1600 includes a body 1610 thereof that is a single piece component having an open top 1654 therein for inserting a portion of the headphones 10 therein. The protective case 1600 further includes a retention piece 1620 that extends over at least a portion of the open top 1654.

In some embodiments, the body 1610 may be a hard shell body that is formed of an impact resistant or impact absorbing material. In some embodiments, the body 1610 may be particularly shaped and/or sized to correspond to a shape and/or size of a portion of the headphones 10 received therein. In some embodiments, the body 1610 may be constructed of a soft material that conforms to the shape of the headphones 10 when the headphones 10 are received therein. In still other embodiments, the body 1610 may be formed of a combination of hard and soft components.

The body 1610 of the protective case 1600 further defines a cavity 1618 for holding the headphones 10 therein, particularly the ear cups 14, 16 thereof (not shown). The cavity 1618 may be particularly shaped, sized, and/or contoured to fit a particular type of headphones 10 or may be more generally shaped, sized, and/or contoured to hold a variety of different headphone types. The cavity 1618 may be defined by walls of the body 1610. The cavity 1618 may be open to an exterior of the protective case 1600 via the open top 1654 to receive the ear cups 14, 16 through the open top 1654, as described in further detail herein. In some embodiments, one or more interior walls of the body 1610 may be lined with a soft material, such as velvet or the like, to prevent the headphones 10 from becoming scratched, chipped, marred, or the like when received within the cavity.

The open top 1654 generally provides access to the interior of the protective case 1600 (e.g., the cavity 1618). The open top 1654 may generally be shaped, sized, and configured such that the ear cups 14, 16 of the headphones 10 can pass into the cavity 1618 of the protective case 1600 while the headband 12 remains external to the cavity 1618. In addition, the body 1610 (e.g., a top 1650 thereof) may further include the retention piece 1620 coupled thereto. The retention piece 1620 may be coupled to one surface of the body 1610 and may be removably coupled to another surface of the body 1610. For example, the retention piece 1620 may include a first portion coupled to the body 1610 (e.g., a backside of the body 1610) and a second portion located at a distal end of the first portion, the second portion removably couplable to a catch (not shown). The catch may be any component that can engage with the retention piece 1620, such as a protrusion, an indentation, a hook, a magnet, and/or the like. In one illustrative example, the retention piece 1620 may be a silicone latch. In another illustrative example, the retention piece 1620 may have a magnet integrated thereon or therewith, and may hold the retention piece 1620 to the catch. In some embodiments, the retention piece 1620 may be lockable (e.g., via a keyed lock, a combination style lock, a biometric style lock).

Referring particularly to FIGS. 16B-16C, the protective case 1600 may include one or more features for accessing, charging, and/or actuating the headphones 10 when the headphones are received within the protective case 1600 (e.g., within the cavity 1618 depicted in FIG. 16A). Referring to FIG. 16C, in some embodiments, a base 1640 of the body 1610 may include a base wall 1642 having an aperture 1644 therein, such as an access port, recess, or the like. The aperture 1644 may be shaped and sized to allow certain ones of the accessories 50 (FIG. 1B) to be passed through the base wall 1642 into the interior of the protective case 1600. For example, the aperture 1644 may be shaped and sized such that a charging cable can pass through the base wall 1642 and couple to a charging/data port on the headphones 10 when the headphones 10 are received within the protective case 1600. In some embodiments, the aperture 1644 may include a charging/data port 1646 therein. Such a charging/data port 1646 may be electrically coupled to the headphones 10 when the headphones are placed within the protective case 1600 (e.g., via a conductive charging pad or the like). As such, when power is supplied to the charging/data port 1646 (e.g., via a cable that is inserted into the charging/data port 1646), charging capabilities are provided by the protective case 1600 to the headphones 10 when the headphones 10 are received within the protective case 1600. In addition or in the alternative, the charging/data port 1646 may be electrically coupled to a battery integrated within the protective case to charge the battery, which is then used to charge the headphones 10 when received within the protective case 1600 as described herein.

Referring to FIGS. 16B-16C, a cover 1648 that is molded to correspond to the aperture 1644 (e.g., shaped and sized correspondingly to the aperture 1644) may cover the aperture 1644 when the aperture 1644 is not used or needed (e.g., as shown in FIG. 16B) and may be removed from the aperture 1644 when the aperture 1644 is used or needed (e.g., as shown in FIG. 16C). In some embodiments, the cover 1648 may be partially fixed to the body 1610 such that a portion of the cover 1648 can be removed to access the aperture 1644. In other embodiments, the cover 1648 may be fully removable from the body 1610 to access the aperture 1644. In some embodiments, the cover 1648 may be constructed of a deformable material such as rubber or silicone to provide a watertight and/or dust tight seal when installed over or inside the aperture 1644.

While not depicted in FIGS. 16A-16C, one or more internal walls may be formed within the cavity 1618. In some embodiments, the one or more internal walls may be particularly shaped, sized, and positioned to ensure appropriate placement of the headphones 10 within the cavity 1618 (e.g., to ensure that the protective case 1600 holds the headphones 10 properly). In some embodiments, the one or more internal walls may include various components therein for ensuring that the headphones 10 are actuated, switched off, placed in a power save mode, charged, and/or the like. For example, the one or more internal walls may include a magnet that aligns with a magnetic switch within the headphones 10 for actuating one or more headphone features (e.g., shutting off the headphones 10, placing the headphones 10 in a power save mode, and/or the like). In another example, the one or more internal walls may include a wireless charging component that aligns with wireless charging components of the headphones 10 and allows for wireless charging of the headphones 10 when received within the cavity (as described above). In some embodiments, the internal walls of the body 1610 may have one or more surface features such as recesses, grooves, indentations, protrusions, flanges, detents, threads, and/or the like that, when contacted or otherwise engaged with an object, may interface with the object and hold the object within the cavity.

Referring to FIGS. 16A-16B, the body 1610 of the protective case 1600 may have one or more attachment features 1684 extending from the body 1610 and providing a point of fixture or attachment of an accessory or the like. For example, the one or more attachment features 1684 may include one or more protrusions, bumps, knobs, projections, posts, loops, recesses, apertures, or similar components that are particularly shaped, sized, configured, and/or oriented for the purposes of providing a point on the body 1610 of the protective case 1600 for fixture or attachment of an accessory. For example, as depicted in the embodiment of FIGS. 16A-16B, the one or more attachment features 1684 may include a key loop disposed on an exterior surface of the body 1610 that provide an attachment point for a key ring, a carabiner, or the like. In some embodiments, a plurality of key loops may be disposed on the exterior surface of the body 1610 and may be serve as anchor points for a strap, such as a shoulder strap or the like.

It should be appreciated that the components described herein, regardless of a particular embodiment in which it is depicted or described, can be used interchangeably in any of the embodiments depicted herein. That is, various components and features described herein are not solely restricted to a particular embodiment in which they are depicted and described.

It should now be understood that embodiments described herein include various protective cases for over-the-ear headphones. The protective cases herein generally cover at least a portion of the headphones (including up to the entirety of the headphones) and may include one or more other features for retaining the headphones within the case. In some embodiments, the protective cases may include one or more additional features, including, but not limited to, charging/data ports, battery packs, solar panels, wireless charging pads magnetic switches, additional storage pouches, locking components, security straps, shoulder straps, access ports, impact resistant features, water resistant/water-proof features, dust sealing features, and/or coupling features for coupling to other devices, bags, cases, or the like. In some embodiments, the protective cases described herein may have components for coupling one or more accessories thereto, such as, for example, a wallet accessory, a stand accessory, a key ring accessory, a clip accessory, a carabiner accessory, a trinket accessory, a supplemental battery pack, a solar panel, travel adaptors, cables, or the like.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A protective case for headphones, the protective case comprising:
a body having a first portion and a second portion hingedly coupled together, the first portion and the second portion defining a cavity for receiving ear cups of the headphones, the first portion and/or the second portion comprising a plurality of apertures through walls of the body that allow a headband of the headphones to extend therethrough,
wherein the first portion and the second portion are joinable together to enclose the ear cups of the headphones within the cavity.

2. The protective case of claim 1, wherein the body comprises the walls, the walls being shaped, sized, and arranged to hold the headphones within the cavity.

3. The protective case of claim 1, further comprising one or more storage pockets disposed on one or more of the walls of the body.

4. The protective case of claim 1, further comprising one or more internal walls extending within the cavity.

5. The protective case of claim 4, wherein the one or more internal walls comprise a magnet and/or wireless charging features.

6. The protective case of claim 1, wherein at least a portion of the body is formed of a magnetic material.

7. The protective case of claim 1, further comprising a pouch coupled to the body.

8. The protective case of claim 7, wherein the pouch is detachable from the body.

9. The protective case of claim 8, wherein the pouch comprises an interior for receiving the protective case therein when detached.

10. The protective case of claim 1, further comprising one or more attachment features extending from the body, each of the one or more attachment features providing a point of attachment for one or more accessories.

11. The protective case of claim 1, wherein the body further comprises a base having an aperture formed therein for accessing a charging port disposed within the aperture.

12. The protective case of claim 11, further comprising a removable cover disposed over the aperture.

13. A protective case for headphones, the protective case comprising:
a body defining a cavity for receiving and enclosing ear cups of the headphones, the body comprising at least one wall defining a plurality of apertures therethrough that allow a headband of the headphones to extend through the plurality of apertures.

14. The protective case of claim 13, wherein the at least one wall is constructed of a flexible material.

15. The protective case of claim 13, wherein the body further comprises a first portion and a second portion joinable together to define the cavity.

16. The protective case of claim 15, wherein the first portion is hingedly coupled to the second portion.

17. The protective case of claim 15, wherein the first portion is retained to the second portion via a strap.

18. The protective case of claim 13, further comprising one or more storage pockets disposed on the at least one wall of the body.

19. The protective case of claim 13, further comprising one or more internal walls extending within the cavity, the one or more internal walls comprising a magnet and/or wireless charging features.

20. A protective case for headphones, the protective case comprising:
a body having defining a cavity for receiving and enclosing ear cups of the headphones, the body comprising at least one wall defining a plurality of apertures therethrough that allow a headband of the headphones to extend through the plurality of apertures;
one or more internal walls disposed within the cavity, the one or more internal walls comprising a magnet and/or wireless charging features; and
a pouch removably coupled to the body, the pouch comprising an interior for receiving the protective case therein when detached.
